(19) United States
(12) Patent Application Publication
(10) Pub. No.: US 2025/0110756 A1
(43) Pub. Date: Apr. 3, 2025

(54) Devices, Methods, and Graphical User Interfaces for Updating a Status Region

(71) Applicant: Apple Inc., Cupertino, CA (US)

(72) Inventors: Shubham Kedia, Santa Clara, CA (US); Chanaka G. Karunamuni, San Jose, CA (US)

(21) Appl. No.: 18/886,907

(22) Filed: Sep. 16, 2024

Related U.S. Application Data
(60) Provisional application No. 63/541,253, filed on Sep. 28, 2023.

(51) Int. Cl. G06F 9/451; G06F 3/04817

(52) U.S. Cl. CPC G06F 9/451; G06F 3/04817

(57) ABSTRACT

A computer system displays a status bar that includes one or more status icons and displays, outside of the status bar, a user interface of respective software. The computer system, in response to detecting the occurrence of an alert, displays in the status bar an indication of the alert, including: in accordance with a determination that the alert corresponds to the first status icon of the one or more status icons in the status bar, updating the first status icon to include an indication of an occurrence of the alert. The computer system, in response to detecting the input: in accordance with a determination that the input is directed to the first status icon in the status bar, performs a first operation; and in accordance with a determination that the input is directed to a second status icon in the status bar, forgoes performing the first operation.

### RELATED APPLICATIONS

This application claims priority to U.S. Provisional Application No. 63/541,253, filed Sep. 28, 2023, which is hereby incorporated by reference in its entirety.

### TECHNICAL FIELD

This relates generally to electronic devices with touch-sensitive surfaces, including but not limited to electronic devices with touch-sensitive surfaces that include a display area having a status region.

### BACKGROUND

The use of touch-sensitive surfaces as input devices for computers and other electronic computing devices has increased significantly in recent years. Example touch-sensitive surfaces include touchpads and touch-screen displays. Such surfaces are widely used to manipulate user interfaces and objects therein on a display. Example user interface objects include digital images, video, text, icons, and control elements such as buttons and other graphics.

Example manipulations include adjusting the position and/or size of one or more user interface objects or activating buttons or opening files/applications represented by user interface objects, as well as associating metadata with one or more user interface objects or otherwise manipulating user interfaces. Example user interface objects include digital images, video, text, icons, control elements such as buttons and other graphics.

But methods for performing these manipulations are cumbersome and inefficient. For example, using a sequence of mouse based inputs to select one or more user interface objects and perform one or more actions on the selected user interface objects is tedious and creates a significant cognitive burden on a user. In addition, these methods take longer than necessary, thereby wasting energy. This latter consideration is particularly important in battery-operated devices.

### SUMMARY

Accordingly, there is a need for electronic devices with faster, more efficient methods and interfaces for viewing status information and accessing controls for controlling applications. Such methods and interfaces optionally complement or replace conventional methods for viewing status information and accessing controls for controlling applications. Such methods and interfaces reduce the number, extent, and/or nature of the inputs from a user and produce a more efficient human-machine interface. For battery-operated devices, such methods and interfaces conserve power and increase the time between battery charges.

The above deficiencies and other problems associated with user interfaces for electronic devices (or more generally, computer systems) with touch-sensitive surfaces are reduced or eliminated by the disclosed devices. In some embodiments, the device is a desktop computer. In some embodiments, the device is portable (e.g., a notebook computer, tablet computer, or handheld device). In some embodiments, the device is a personal electronic device (e.g., a wearable electronic device, such as a watch). In some embodiments, the device has a touchpad. In some embodiments, the device has a touch-sensitive display (also known as a “touch screen” or “touch-screen display”). In some embodiments, the device has a graphical user interface (GUI), one or more processors, memory and one or more modules, programs or sets of instructions stored in the memory for performing multiple functions. In some embodiments, the user interacts with the GUI primarily through stylus and/or finger contacts and gestures on the touch-sensitive surface. In some embodiments, the functions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a non-transitory computer readable storage medium or other computer program product configured for execution by one or more processors.

In accordance with some embodiments, a method includes displaying, via the display generation component, a status bar that includes one or more status icons, wherein a first status icon of the one or more status icons indicates a state of a first function of the computer system. The method includes displaying outside of the status bar, via the display generation component, a user interface of respective software executing on the computer system and detecting an occurrence of an alert. The method further includes, in response to detecting the occurrence of the alert, while continuing to display the user interface of the respective software outside of the status bar, displaying in the status bar an indication of the alert, including: in accordance with a determination that the alert corresponds to the first status icon of the one or more status icons in the status bar, updating the first status icon to include an indication of an occurrence of the alert. The method includes detecting an input directed to the status bar and, in response to detecting the input directed to the status bar: in accordance with a determination that the input is directed to the first status icon in the status bar, performing a first operation; and in accordance with a determination that the input is directed to a second status icon in the status bar, wherein the second status icon is different from the first status icon, forgoing performing the first operation.

In accordance with some embodiments, an electronic device (or computer system more generally) includes a display, a touch-sensitive surface, optionally one or more sensors to detect intensities of contacts with the touch-sensitive surface, optionally one or more tactile output generators, one or more processors, and memory storing one or more programs; the one or more programs are configured to be executed by the one or more processors and the one or more programs include instructions for performing or causing performance of the operations of any of the methods described herein. In accordance with some embodiments, a computer readable storage medium has stored therein instructions that, when executed by an electronic device with a display, a touch-sensitive surface, optionally one or more sensors to detect intensities of contacts with the touch-sensitive surface, and optionally one or more tactile output generators, cause the device to perform or cause performance of the operations of any of the methods described herein. In accordance with some embodiments, a graphical user interface on an electronic device with a display, a touch-sensitive surface, optionally one or more sensors to detect intensities of contacts with the touch-sensitive surface, optionally one or more tactile output generators, a memory, and one or more processors to execute one or more programs stored in the memory includes one or more of the elements displayed in any of the methods described herein, which are updated in response to inputs, as described in any of the methods described herein. In accordance with some embodiments, an electronic device includes: a display, a touch-sensitive surface, optionally one or more sensors to detect intensities of contacts with the touch-sensitive surface, and optionally one or more tactile output generators; and means for performing or causing performance of the operations of any of the methods described herein. In accordance with some embodiments, an information processing apparatus, for use in an electronic device with a display, a touch-sensitive surface, optionally one or more sensors to detect intensities of contacts with the touch-sensitive surface, and optionally one or more tactile output generators, includes means for performing or causing performance of the operations of any of the methods described herein.

Thus, electronic devices and other computer systems with and/or in communication with displays, touch-sensitive surfaces, optionally one or more sensors to detect intensities of contacts with the touch-sensitive surface, optionally one or more tactile output generators, optionally one or more device orientation sensors, and optionally an audio system, are provided with improved methods and interfaces for providing status updates, thereby increasing the effectiveness, efficiency, and user satisfaction with such devices. Such methods and interfaces may complement or replace conventional methods for providing status updates.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating example components for event handling in accordance with some embodiments.

FIG. 2 illustrates a portable multifunction device having a touch screen in accordance with some embodiments.

FIG. 3 is a block diagram of an example multifunction device with a display and a touch-sensitive surface in accordance with some embodiments.

FIG. 4A illustrates an example user interface for a menu of applications on a portable multifunction device in accordance with some embodiments.

FIG. 4B illustrates an example user interface for a multifunction device with a touch-sensitive surface that is separate from the display in accordance with some embodiments.

FIGS. 4C1-4C2 illustrate an example state diagram of navigation between various user interfaces of the multifunction devices in accordance with some embodiments.

FIGS. 5A-5AH illustrate example user interfaces for updating status information within a region of a display area in accordance with some embodiments.

FIGS. 6A-6D are flow diagrams of a process for updating status information within a region of a display area in accordance with some embodiments.

### DESCRIPTION OF EMBODIMENTS

Many electronic devices have graphical user interfaces that allow a user to navigate between application user interfaces and/or system user interfaces. Some methods for navigating between user interfaces enable multitasking, such that a respective application continues to update in the background even after navigating away from the respective application user interface. For example, with these methods, a user may need to navigate back to the respective application user interface in order to view the updates. In the embodiments described below, an improved method for providing status updates for a plurality of applications within a persistent status region is provided. This method streamlines the user's ability to view real-time status information for active sessions, thereby eliminating the need for extra, separate steps to navigate back to the respective user interface of the respective application to view a status update.

The processes described below enhance the operability of the devices and make the user-device interfaces more efficient (e.g., by helping the user to provide proper inputs and reducing user mistakes when operating/interacting with the device) through various techniques, including by providing improved visual, audio, and/or tactile feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

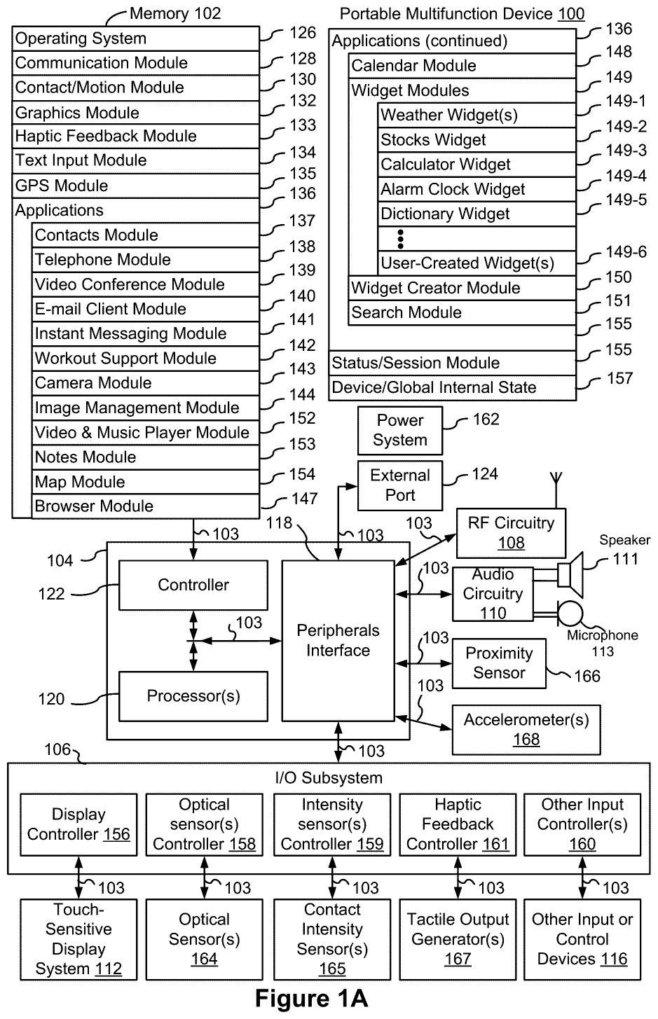

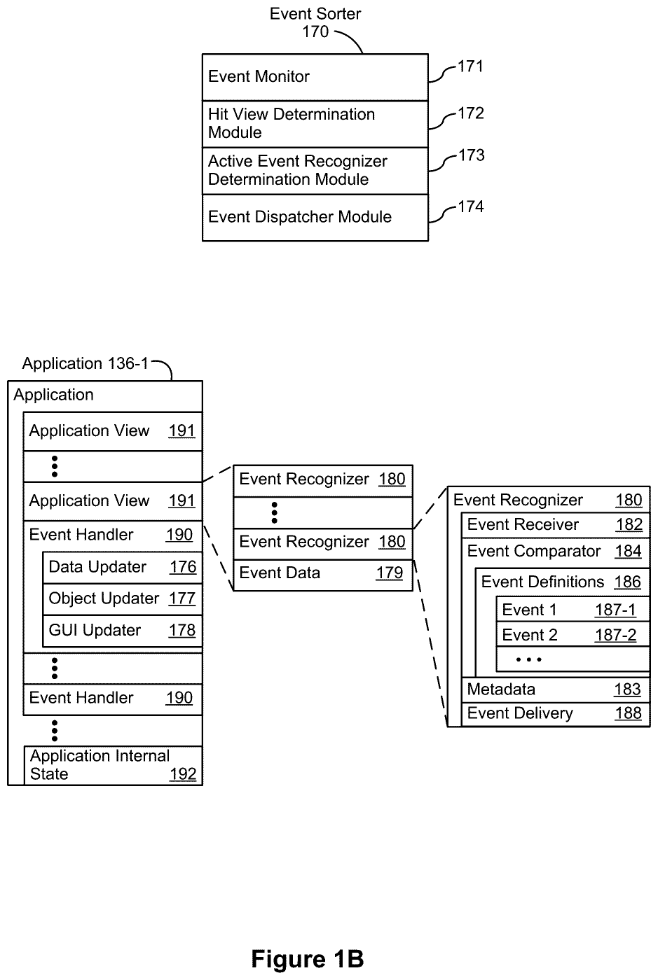

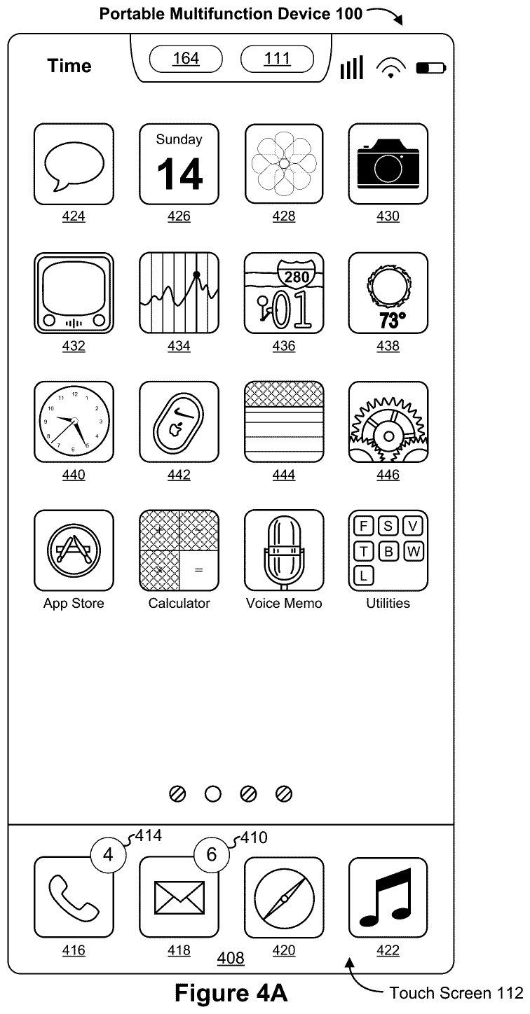

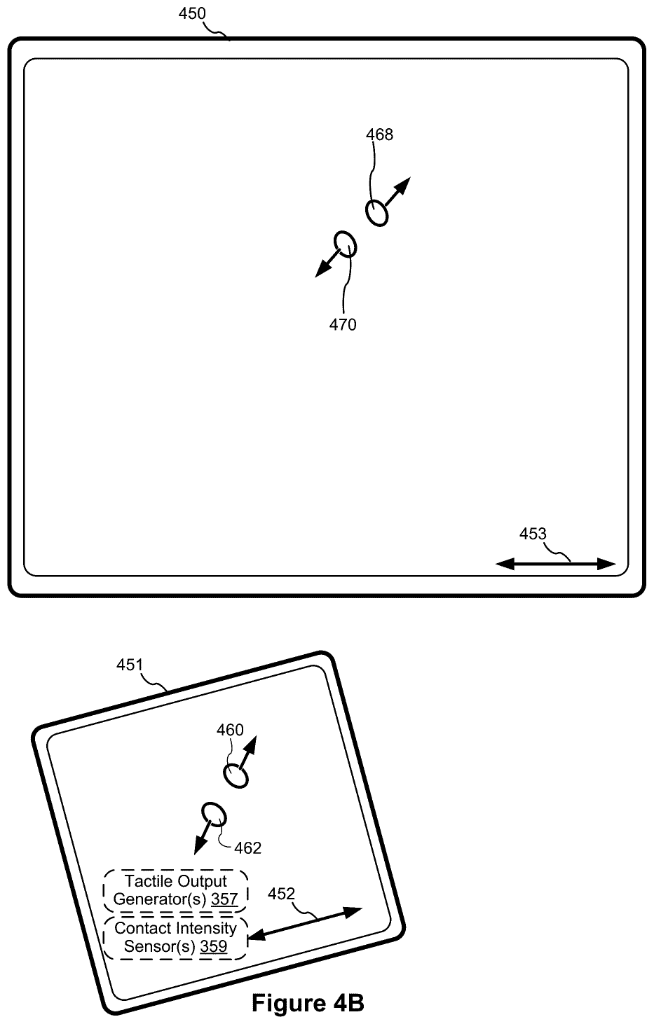

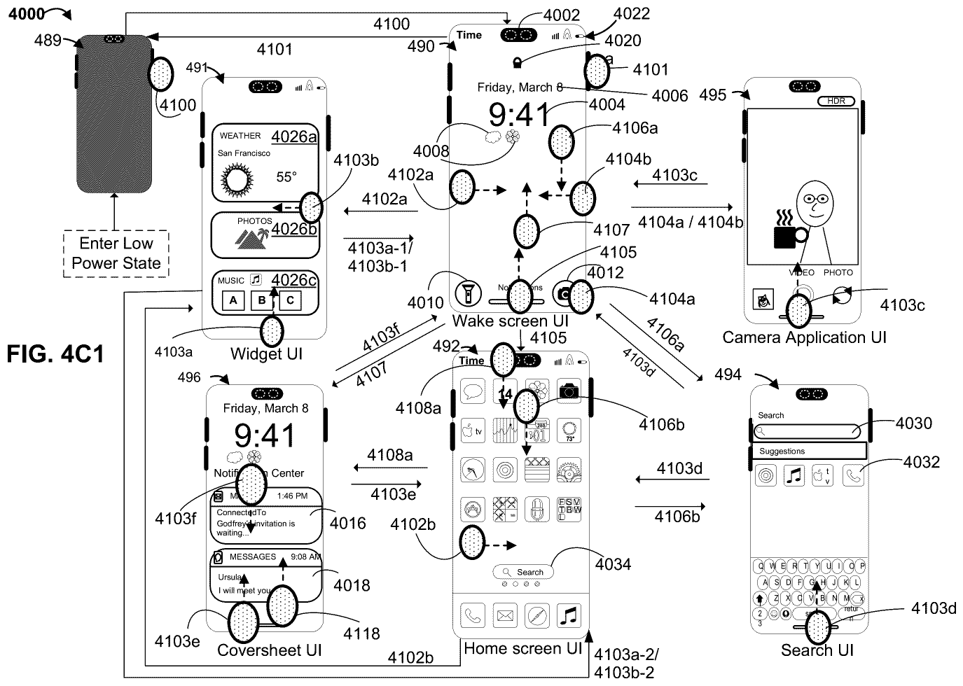

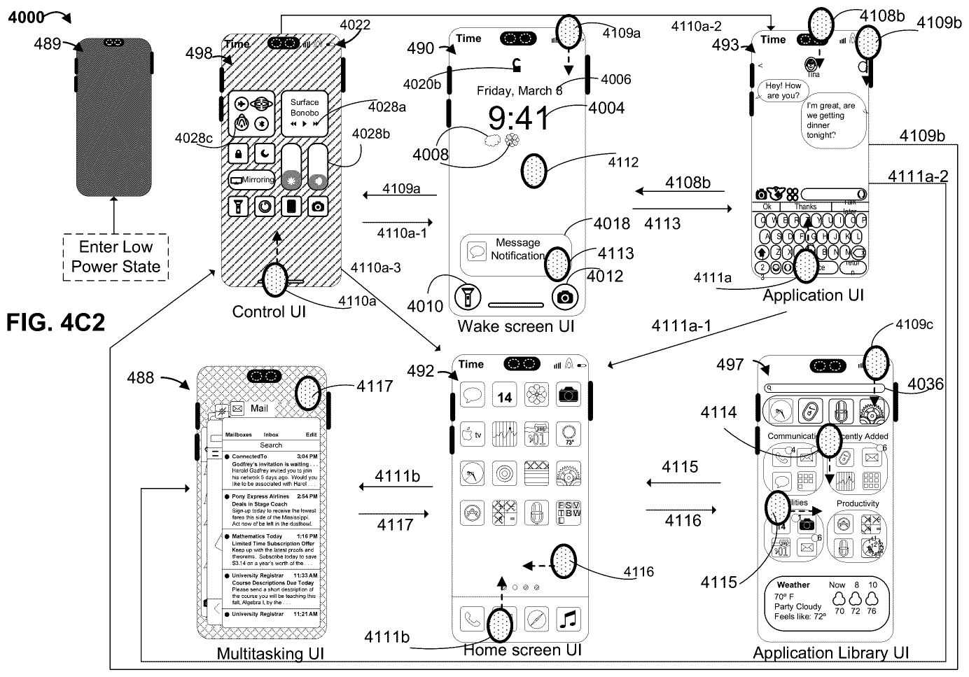

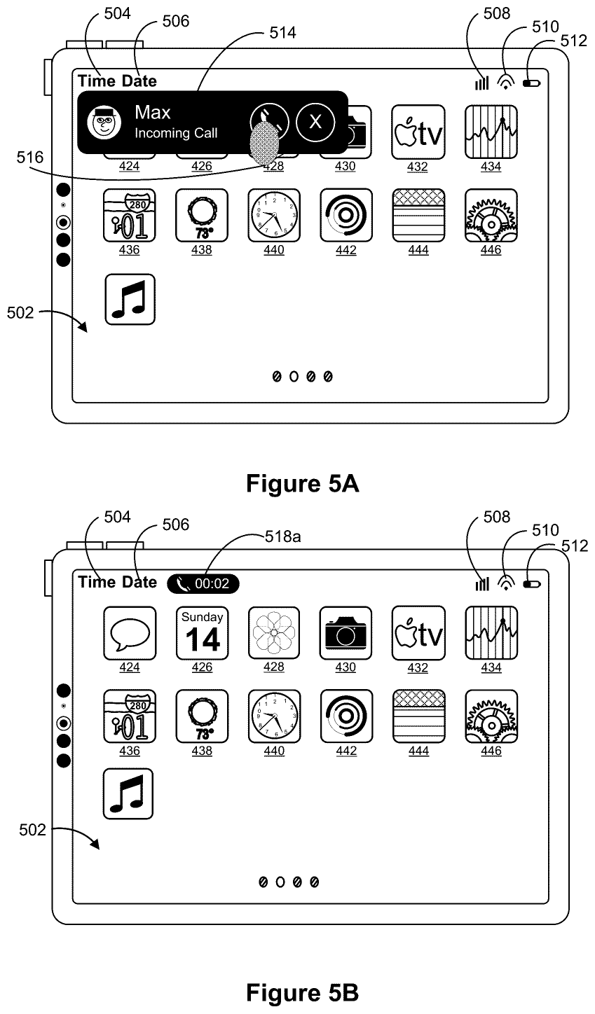

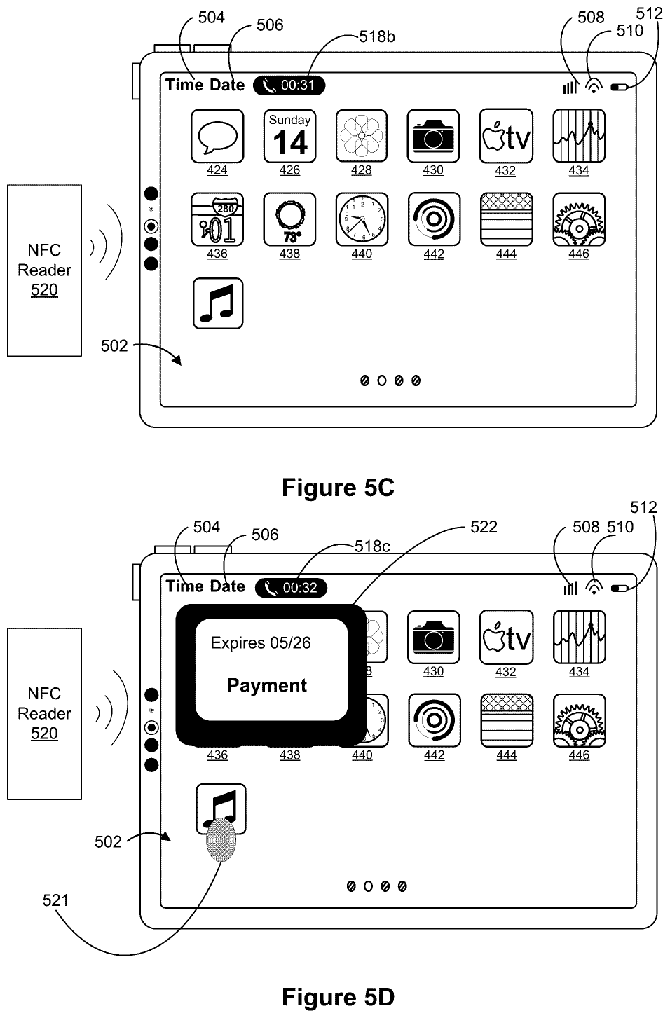

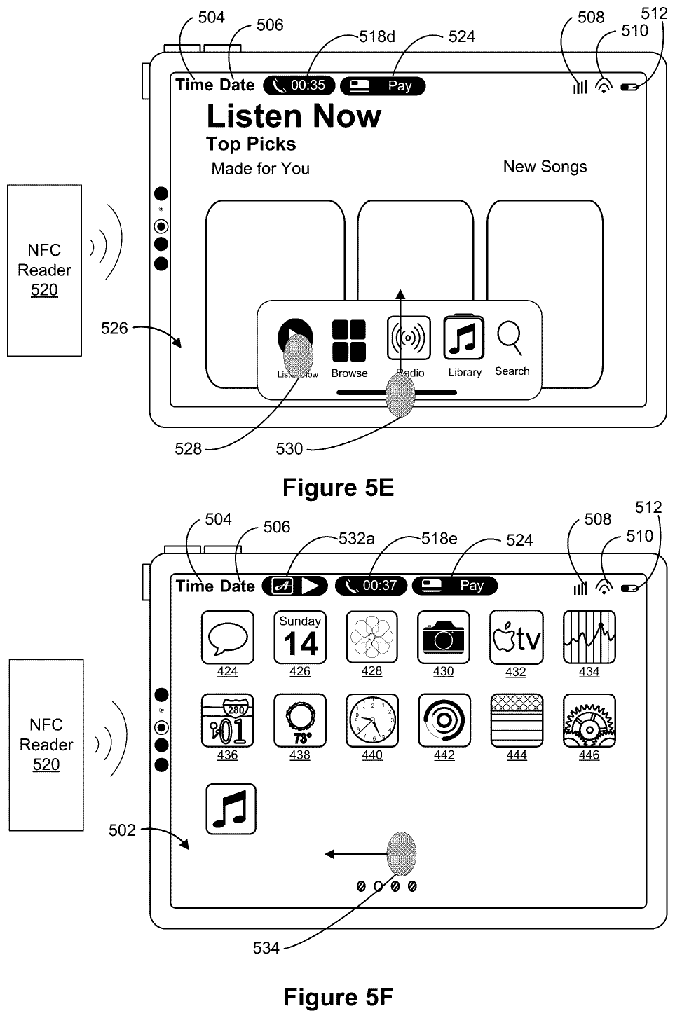

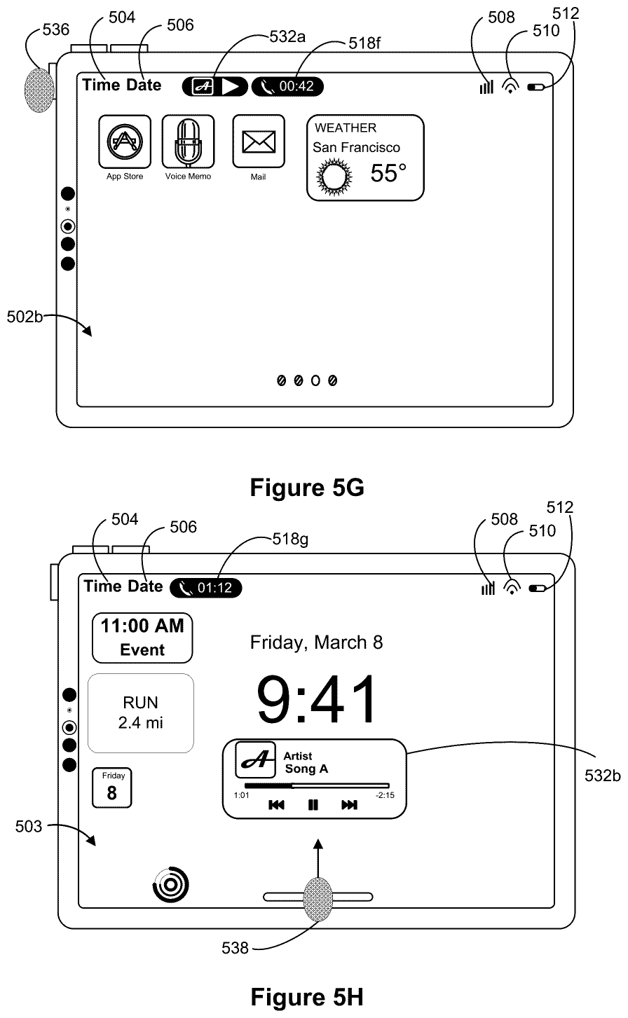

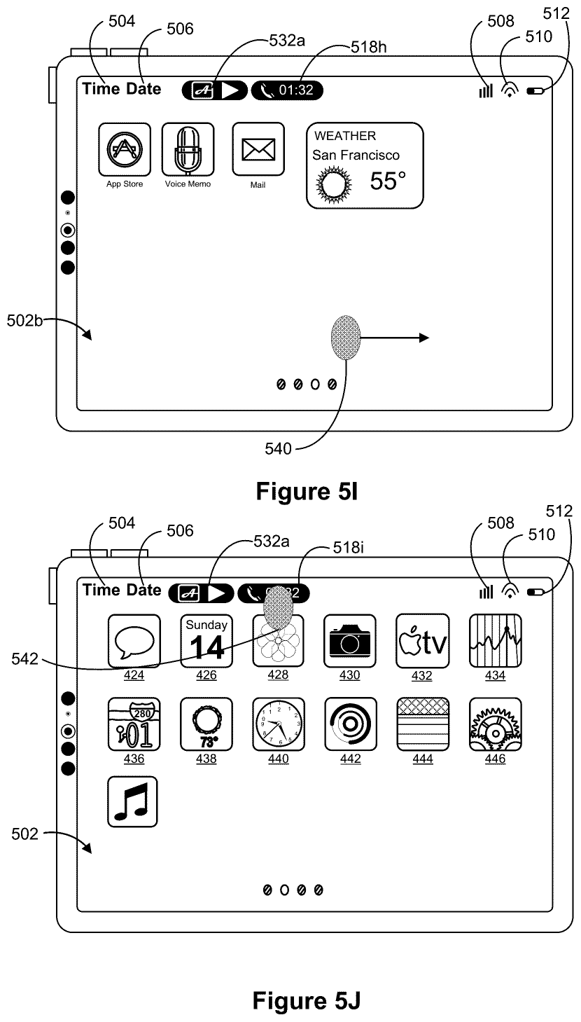

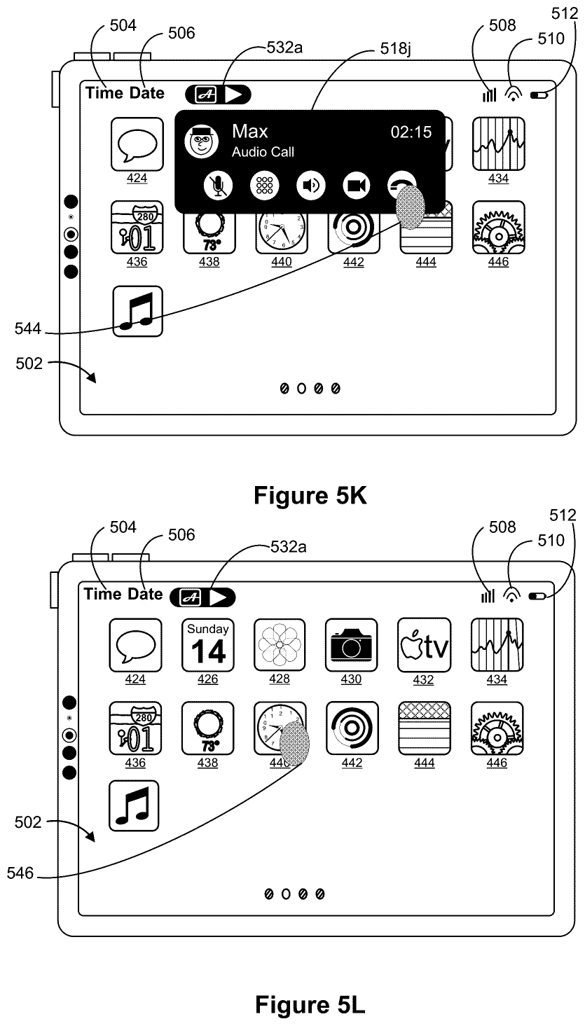

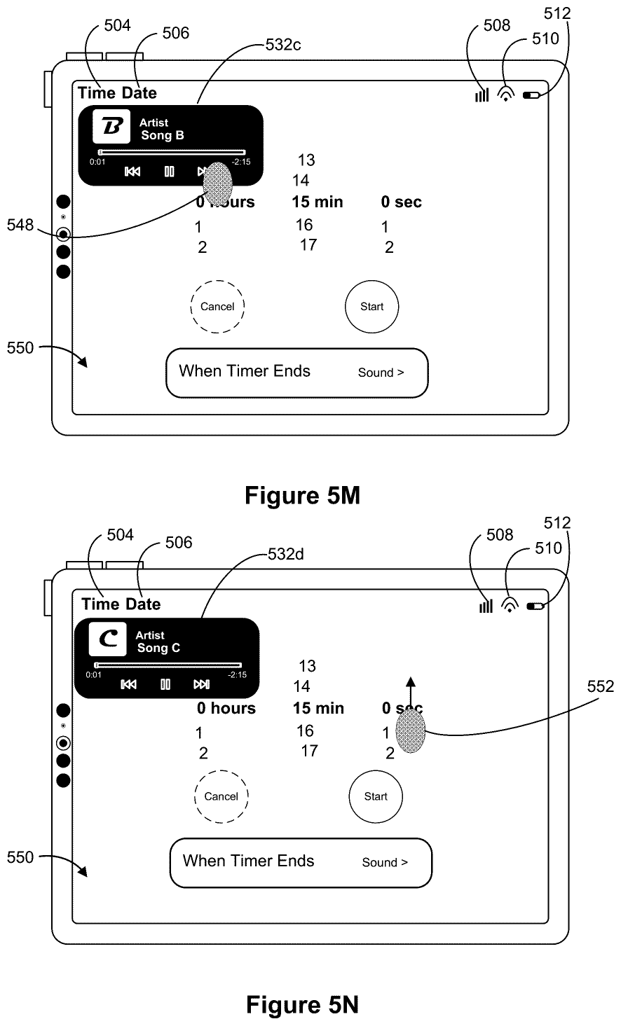

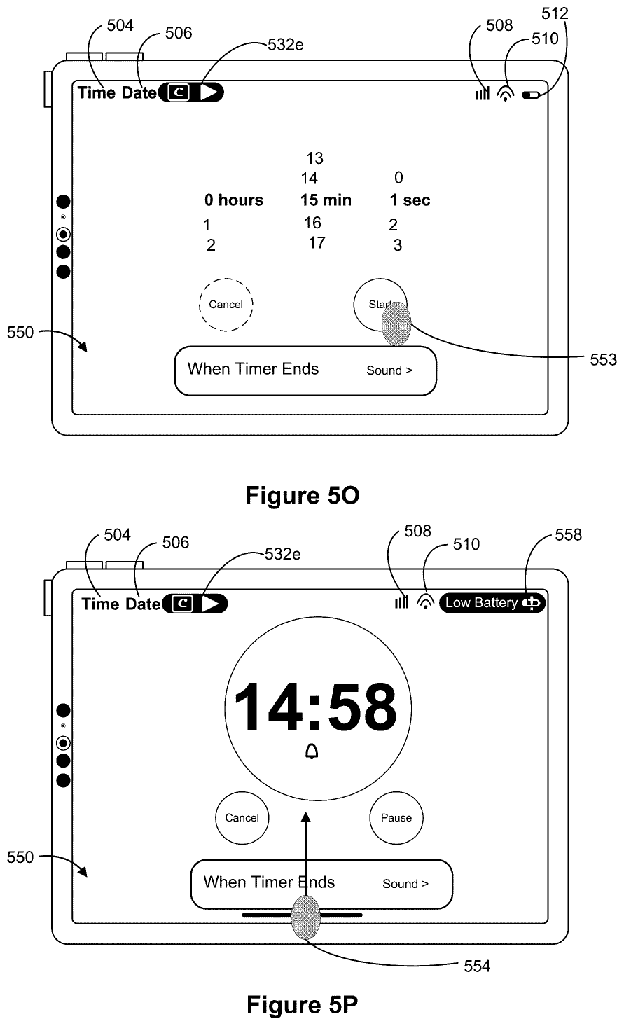

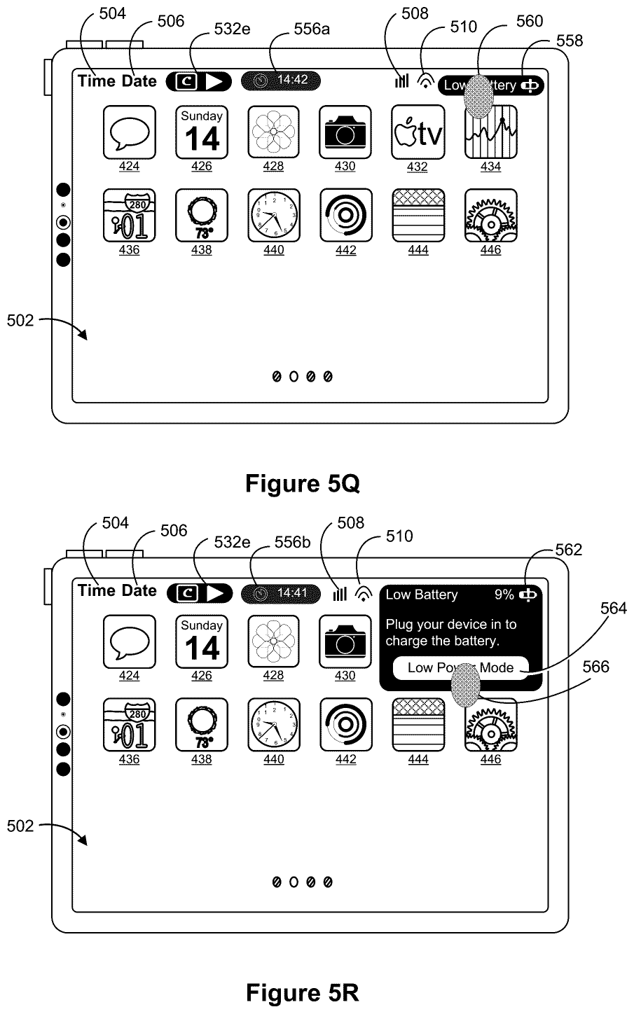

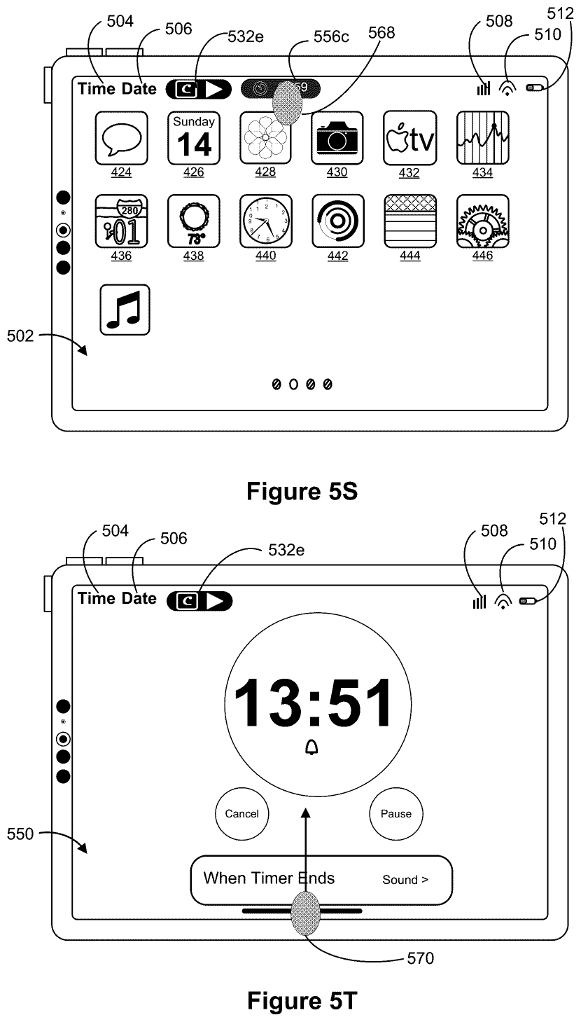

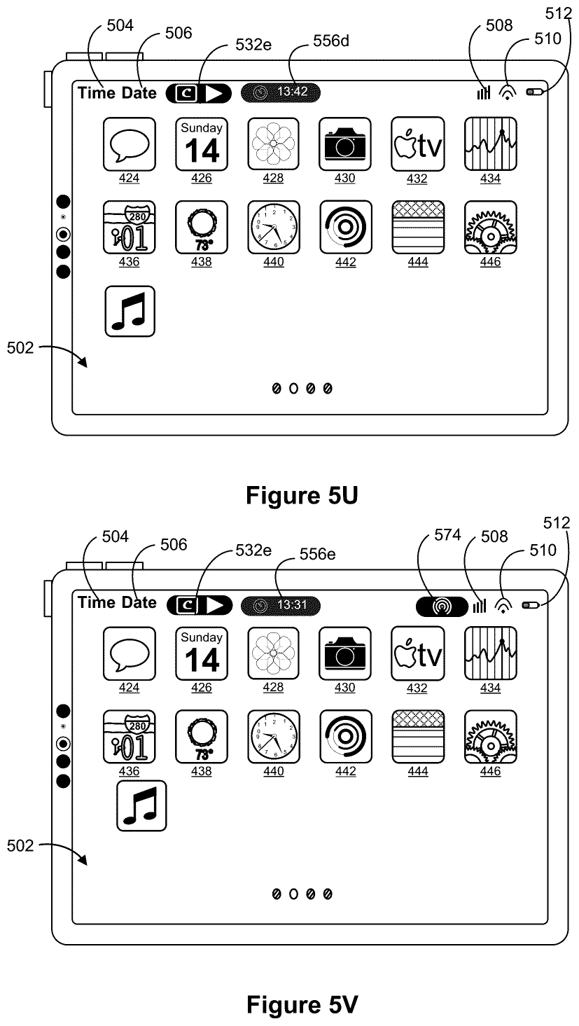

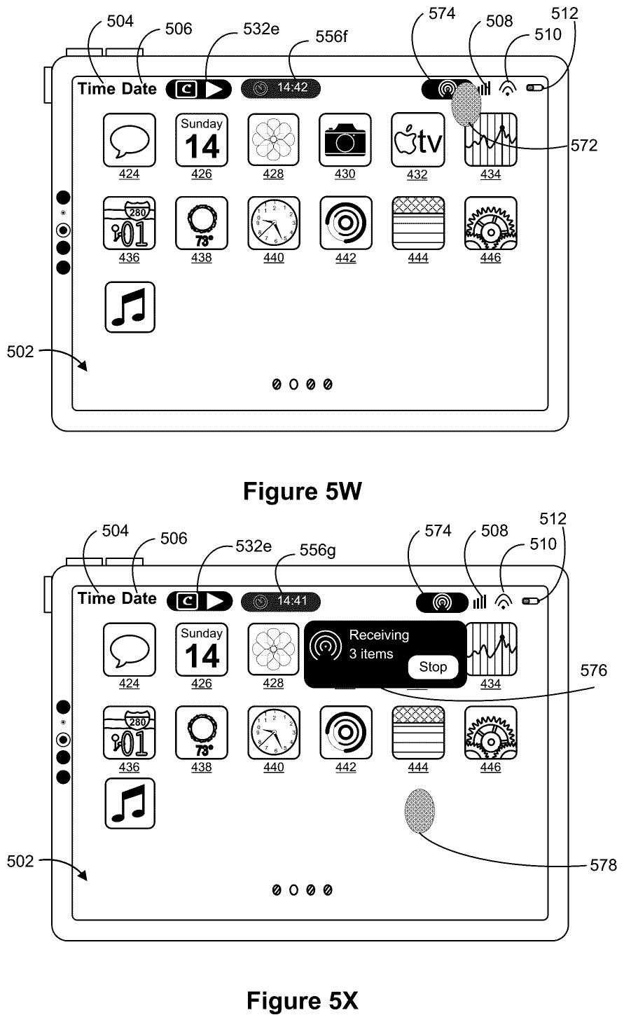

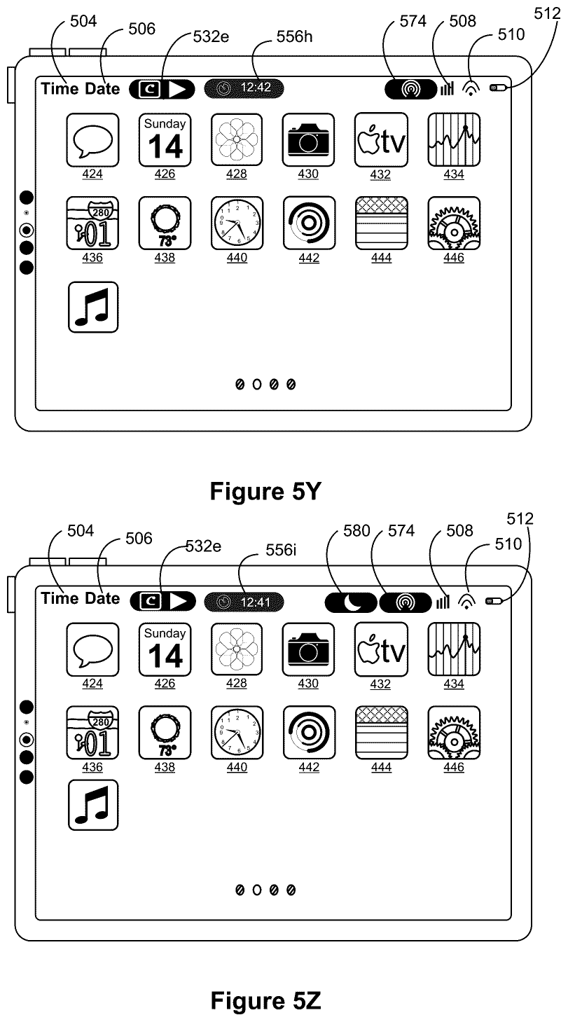

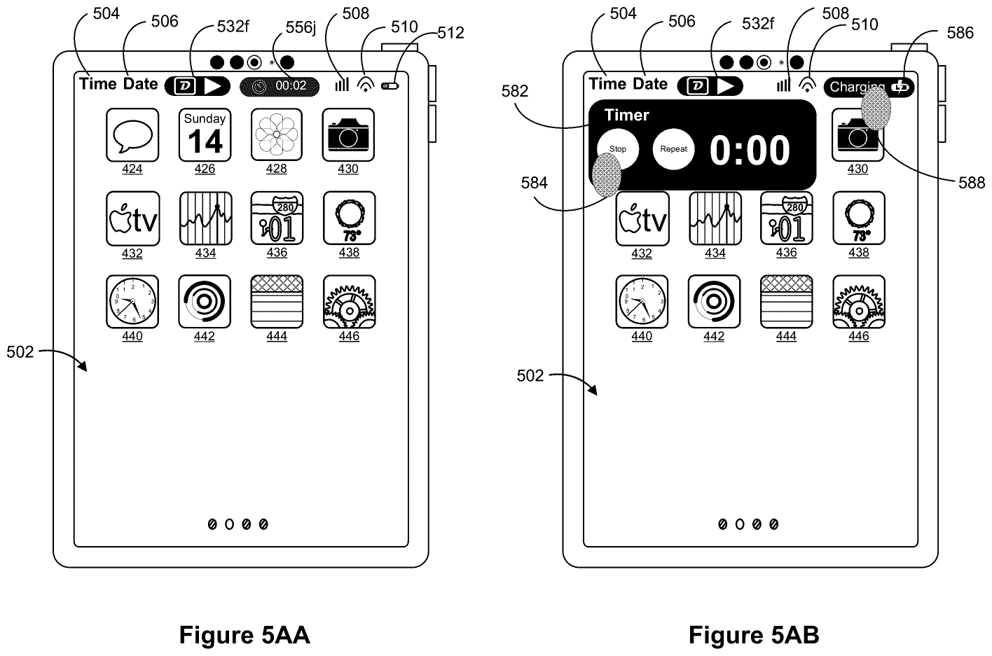

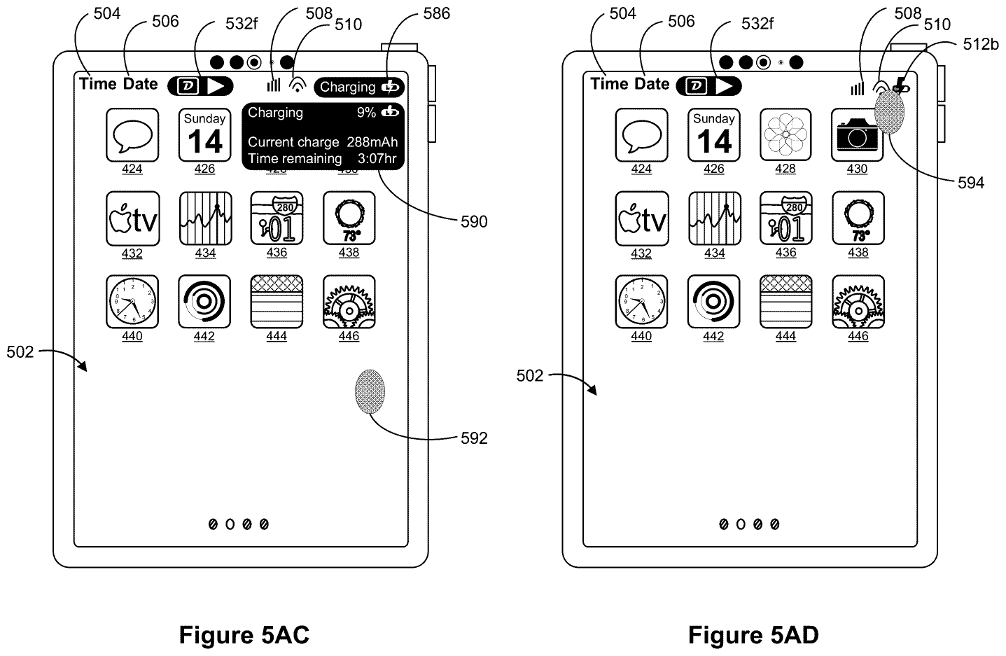

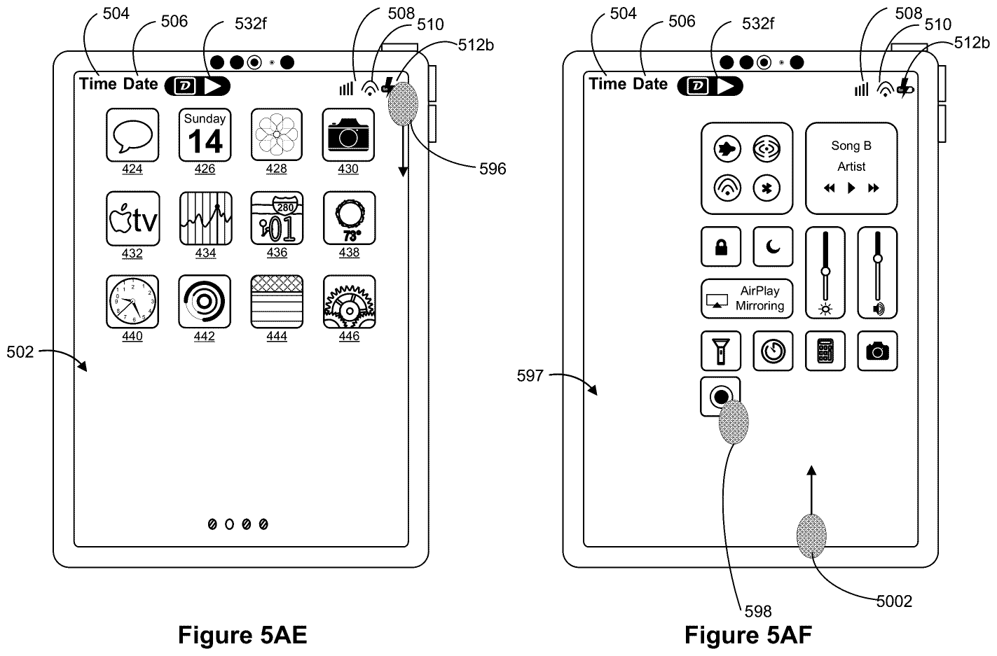

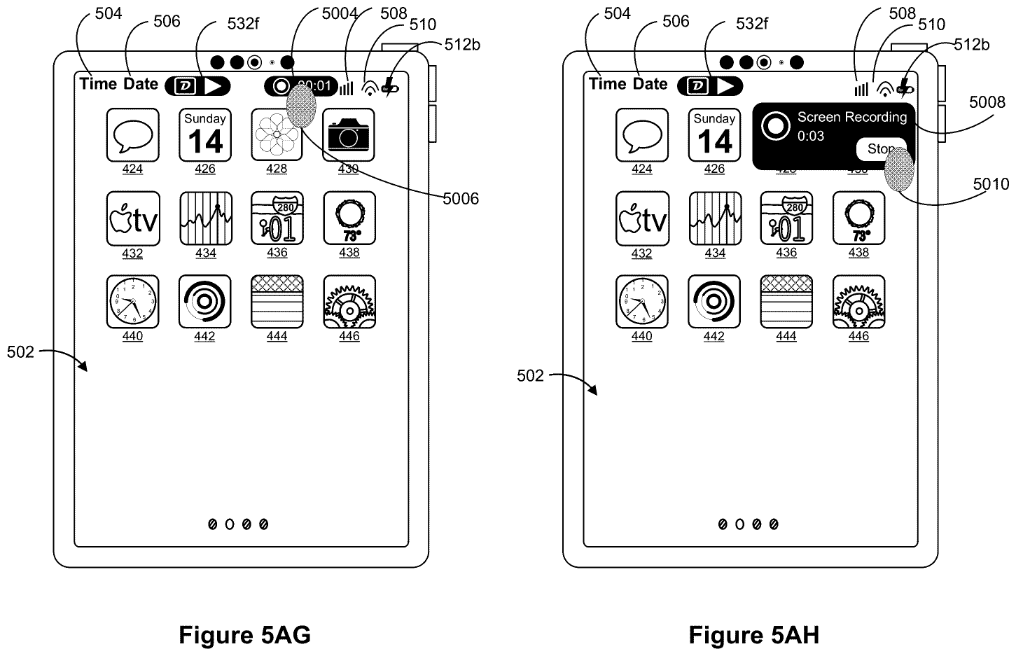

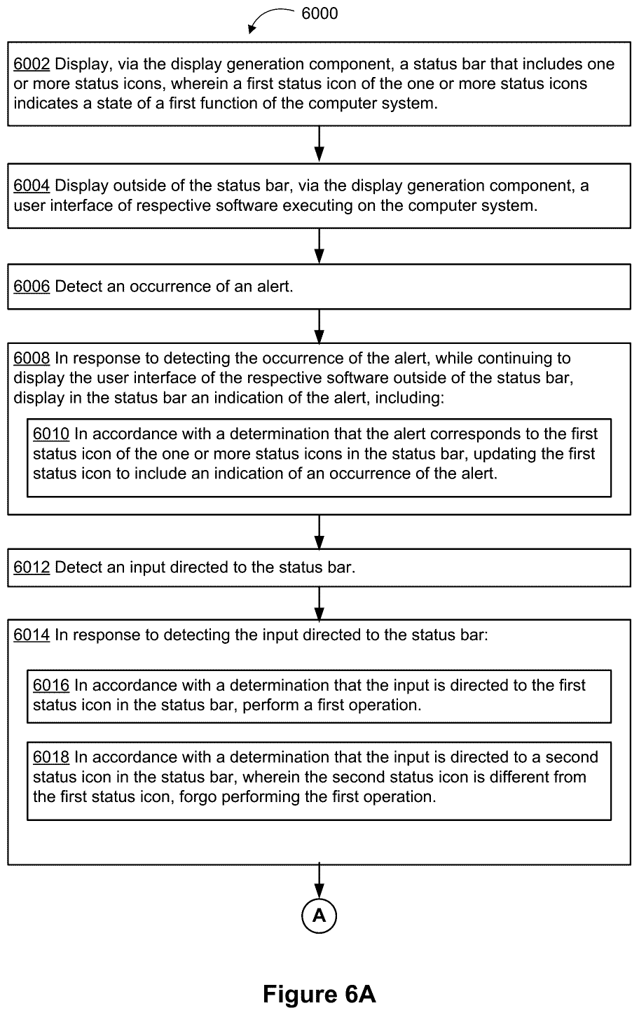

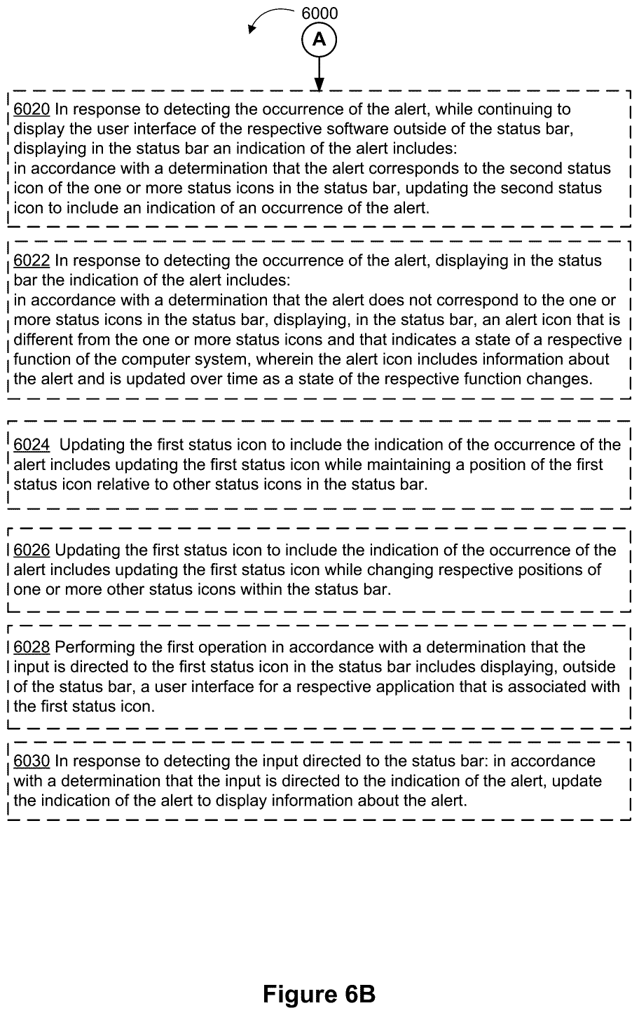

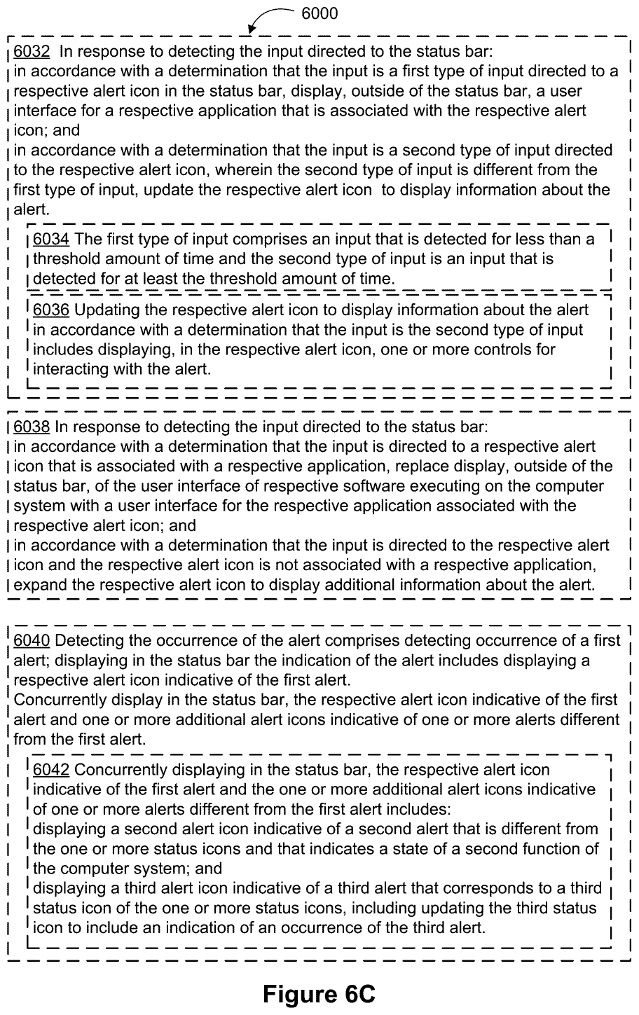

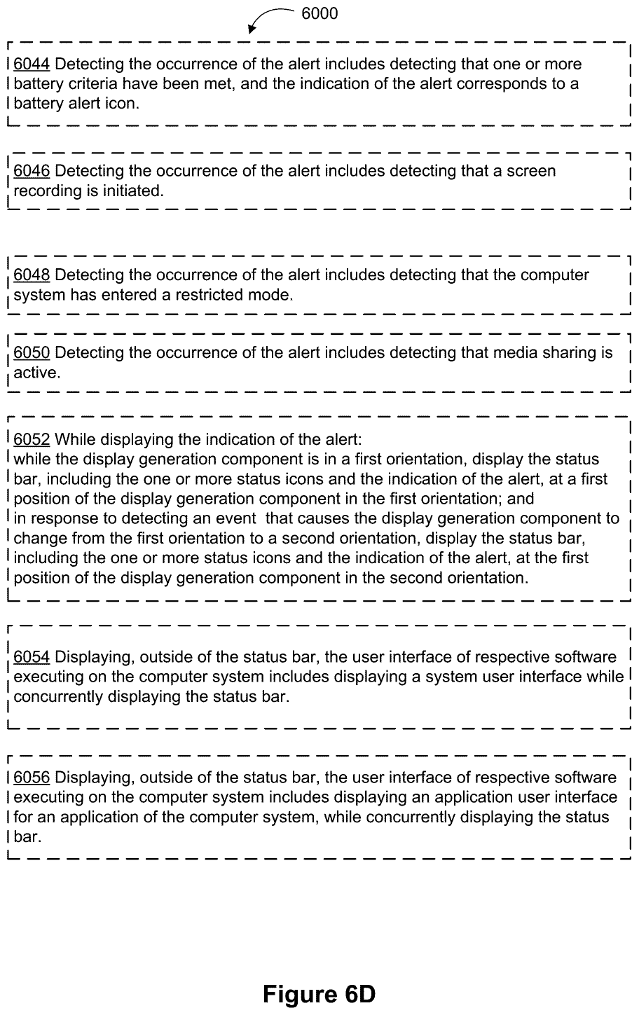

Below, FIGS. 1A-1B, 2, and 3 provide a description of example devices. FIGS. 4A-4C2 and 5A-5AH illustrate example user interfaces for updating status information within a region of a display area in accordance with some embodiments. FIGS. 6A-6D illustrate a flow diagram of a method for updating status information within a region of a display area in accordance with some embodiments. The user interfaces in FIGS. 5A-5AH are used to illustrate the processes in FIGS. 6A-6D.

### Example Devices

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact, unless the context clearly indicates otherwise.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices (and computer systems more generally), user interfaces for such devices, and associated processes for using such devices are described. In some embodiments, the device is a portable communications device, such as a mobile telephone, that also contains other functions, such as PDA and/or music player functions. Example embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch-screen displays and/or touchpads), are, optionally, used. It should also be understood that, in some embodiments, the device is not a portable communications device, but is a desktop computer with a touch-sensitive surface (e.g., a touch-screen display and/or a touchpad).

In the discussion that follows, a computer system in the form of an electronic device that includes a display and a touch-sensitive surface is described. It should be understood, however, that the electronic device optionally includes one or more other physical user-interface devices, such as a physical keyboard, a mouse and/or a joystick.

The device typically supports a variety of applications, such as one or more of the following: a note taking application, a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of computer systems such as portable devices with touch-sensitive displays. FIG. 1A is a block diagram illustrating portable multifunction device 100 with touch-sensitive display system 112 in accordance with some embodiments. Touch-sensitive display system 112 is sometimes called a “touch screen” for convenience, and is sometimes simply called a touch-sensitive display. Device 100 includes memory 102 (which optionally includes one or more computer readable storage mediums), memory controller 122, one or more processing units (CPUs) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more intensity sensors 165 for detecting intensities of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user. Using tactile outputs to provide haptic feedback to a user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, a tactile output pattern specifies characteristics of a tactile output, such as the amplitude of the tactile output, the shape of a movement waveform of the tactile output, the frequency of the tactile output, and/or the duration of the tactile output.

When tactile outputs with different tactile output patterns are generated by a device (e.g., via one or more tactile output generators that move a moveable mass to generate tactile outputs), the tactile outputs may invoke different haptic sensations in a user holding or touching the device. While the sensation of the user is based on the user's perception of the tactile output, most users will be able to identify changes in waveform, frequency, and amplitude of tactile outputs generated by the device. Thus, the waveform, frequency and amplitude can be adjusted to indicate to the user that different operations have been performed. As such, tactile outputs with tactile output patterns that are designed, selected, and/or engineered to simulate characteristics (e.g., size, material, weight, stiffness, smoothness, etc.); behaviors (e.g., oscillation, displacement, acceleration, rotation, expansion, etc.); and/or interactions (e.g., collision, adhesion, repulsion, attraction, friction, etc.) of objects in a given environment (e.g., a user interface that includes graphical features and objects, a simulated physical environment with virtual boundaries and virtual objects, a real physical environment with physical boundaries and physical objects, and/or a combination of any of the above) will, in some circumstances, provide helpful feedback to users that reduces input errors and increases the efficiency of the user's operation of the device. Additionally, tactile outputs are, optionally, generated to correspond to feedback that is unrelated to a simulated physical characteristic, such as an input threshold or a selection of an object. Such tactile outputs will, in some circumstances, provide helpful feedback to users that reduces input errors and increases the efficiency of the user's operation of the device.

In some embodiments, a tactile output with a suitable tactile output pattern serves as a cue for the occurrence of an event of interest in a user interface or behind the scenes in a device. Examples of the events of interest include activation of an affordance (e.g., a real or virtual button, or toggle switch) provided on the device or in a user interface, success or failure of a requested operation, reaching or crossing a boundary in a user interface, entry into a new state, switching of input focus between objects, activation of a new mode, reaching or crossing an input threshold, detection or recognition of a type of input or gesture, etc. In some embodiments, tactile outputs are provided to serve as a warning or an alert for an impending event or outcome that would occur unless a redirection or interruption input is timely detected. Tactile outputs are also used in other contexts to enrich the user experience, improve the accessibility of the device to users with visual or motor difficulties or other accessibility needs, and/or improve efficiency and functionality of the user interface and/or the device. Tactile outputs are optionally accompanied with audio outputs and/or visible user interface changes, which further enhance a user's experience when the user interacts with a user interface and/or the device, and facilitate better conveyance of information regarding the state of the user interface and/or the device, and which reduce input errors and increase the efficiency of the user's operation of the device.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, firmware, or a combination thereof, including one or more signal processing and/or application specific integrated circuits.

Memory 102 optionally includes high-speed random access memory and optionally also includes non-volatile memory, such as one or more magnetic disk storage devices, flash memory devices, or other non-volatile solid-state memory devices. Access to memory 102 by other components of device 100, such as CPU(s) 120 and the peripherals interface 118, is, optionally, controlled by memory controller 122.

Peripherals interface 118 can be used to couple input and output peripherals of the device to CPU(s) 120 and memory 102. The one or more processors 120 run or execute various software programs and/or sets of instructions stored in memory 102 to perform various functions for device 100 and to process data.

In some embodiments, peripherals interface 118, CPU(s) 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

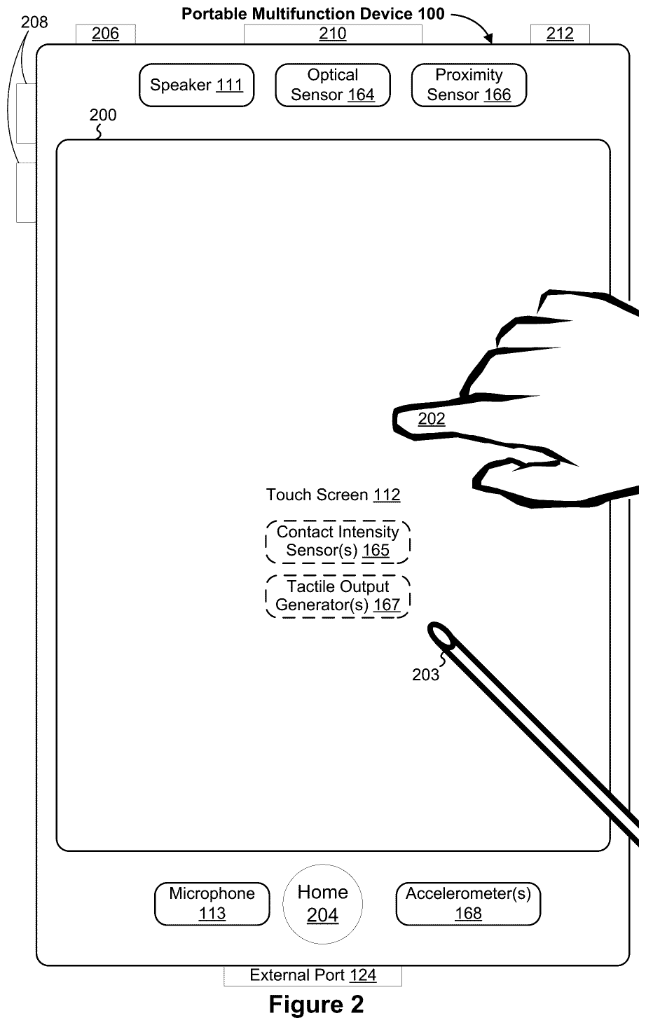

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch-sensitive display system 112 and other input or control devices 116, with peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input or control devices 116. The other input or control devices 116 optionally include physical buttons (e.g., push buttons, rocker buttons, etc.), dials, slider switches, joysticks, click wheels, and so forth. In some alternate embodiments, input controller(s) 160 are, optionally, coupled with any (or none) of the following: a keyboard, infrared port, USB port, stylus, and/or a pointer device such as a mouse. The one or more buttons (e.g., 208, FIG. 2) optionally include an up/down button (e.g., a single button that rocks in opposite directions, or separate up button and down button) for volume control of speaker 111 and/or microphone 113. The one or more buttons optionally include a push button (e.g., 206, FIG. 2).

Touch-sensitive display system 112 provides an input interface and an output interface between the device and a user. Display controller 156 receives and/or sends electrical signals from/to touch-sensitive display system 112. Touch-sensitive display system 112 displays visual output to the user. The visual output optionally includes graphics, text, icons, video, and any combination thereof (collectively termed “graphics”). In some embodiments, some or all of the visual output corresponds to user interface objects. As used herein, the term “affordance” refers to a user-interactive graphical user interface object (e.g., a graphical user interface object that is configured to respond to inputs directed toward the graphical user interface object). Examples of user-interactive graphical user interface objects include, without limitation, a button, slider, icon, selectable menu item, switch, hyperlink, or other user interface control.

Touch-sensitive display system 112 has a touch-sensitive surface, sensor or set of sensors that accepts input from the user based on haptic and/or tactile contact. Touch-sensitive display system 112 and display controller 156 (along with any associated modules and/or sets of instructions in memory 102) detect contact (and any movement or breaking of the contact) on touch-sensitive display system 112 and converts the detected contact into interaction with user-interface objects (e.g., one or more soft keys, icons, web pages or images) that are displayed on touch-sensitive display system 112. In some embodiments, a point of contact between touch-sensitive display system 112 and the user corresponds to a finger of the user or a stylus.

Touch-sensitive display system 112 optionally uses LCD (liquid crystal display) technology, LPD (light emitting polymer display) technology, or LED (light emitting diode) technology, although other display technologies are used in other embodiments. Touch-sensitive display system 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive display system 112. In some embodiments, projected mutual capacitance sensing technology is used, such as that found in the iPhone®, iPod Touch®, and iPad® from Apple Inc. of Cupertino, California.

Touch-sensitive display system 112 optionally has a video resolution in excess of 100 dpi. In some embodiments, the touch screen video resolution is in excess of 400 dpi (e.g., 500 dpi, 800 dpi, or greater). The user optionally makes contact with touch-sensitive display system 112 using any suitable object or appendage, such as a stylus, a finger, and so forth. In some embodiments, the user interface is designed to work with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch-sensitive display system 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164 (e.g., as part of one or more cameras). FIG. 1A shows an optical sensor coupled with optical sensor controller 158 in I/O subsystem 106. Optical sensor(s) 164 optionally include charge-coupled device (CCD) or complementary metal-oxide semiconductor (CMOS) phototransistors. Optical sensor(s) 164 receive light from the environment, projected through one or more lens, and converts the light to data representing an image. In conjunction with imaging module 143 (also called a camera module), optical sensor(s) 164 optionally capture still images and/or video. In some embodiments, an optical sensor is located on the back of device 100, opposite touch-sensitive display system 112 on the front of the device, so that the touch screen is enabled for use as a viewfinder for still and/or video image acquisition. In some embodiments, another optical sensor is located on the front of the device so that the user's image is obtained (e.g., for selfies, for videoconferencing while the user views the other video conference participants on the touch screen, etc.).

Device 100 optionally also includes one or more contact intensity sensors 165. FIG. 1A shows a contact intensity sensor coupled with intensity sensor controller 159 in I/O subsystem 106. Contact intensity sensor(s) 165 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor(s) 165 receive contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch-screen display system 112 which is located on the front of device 100.

Device 100 optionally also includes one or more proximity sensors 166. FIG. 1A shows proximity sensor 166 coupled with peripherals interface 118. Alternately, proximity sensor 166 is coupled with input controller 160 in I/O subsystem 106. In some embodiments, the proximity sensor turns off and disables touch-sensitive display system 112 when the multifunction device is placed near the user's ear (e.g., when the user is making a phone call).

Device 100 optionally also includes one or more tactile output generators 167. FIG. 1A shows a tactile output generator coupled with haptic feedback controller 161 in I/O subsystem 106. In some embodiments, tactile output generator(s) 167 include one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Tactile output generator(s) 167 receive tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch-sensitive display system 112, which is located on the front of device 100.

Device 100 optionally also includes one or more accelerometers 168. FIG. 1A shows accelerometer 168 coupled with peripherals interface 118. Alternately, accelerometer 168 is, optionally, coupled with an input controller 160 in I/O subsystem 106. In some embodiments, information is displayed on the touch-screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

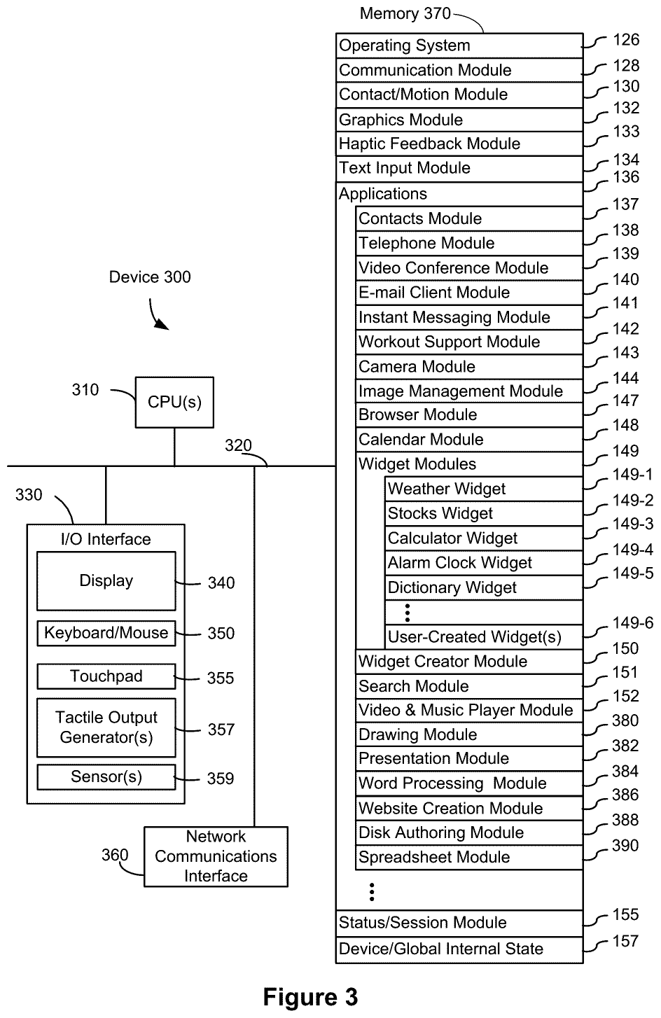

In some embodiments, the software components stored in memory 102 include operating system 126, communication module (or set of instructions) 128, contact/motion module (or set of instructions) 130, graphics module (or set of instructions) 132, haptic feedback module (or set of instructions) 133, text input module (or set of instructions) 134, Global Positioning System (GPS) module (or set of instructions) 135, and applications (or sets of instructions) 136. Furthermore, in some embodiments, memory 102 stores device/global internal state 157, as shown in FIGS. 1A and 3. Device/global internal state 157 includes one or more of: active application state, indicating which applications, if any, are currently active; display state, indicating what applications, views or other information occupy various regions of touch-sensitive display system 112; sensor state, including information obtained from the device's various sensors and other input or control devices 116; and location and/or positional information concerning the device's location and/or attitude.

Operating system 126 (e.g., iOS, Darwin, RTXC, LINUX, UNIX, OS X, WINDOWS, or an embedded operating system such as Vx Works) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used in some iPhone®, iPod Touch®, and iPad® devices from Apple Inc. of Cupertino, California. In some embodiments, the external port is a Lightning connector that is the same as, or similar to and/or compatible with the Lightning connector used in some iPhone®, iPod Touch®, and iPad® devices from Apple Inc. of Cupertino, California. In some embodiments, the external port is a USB Type-C connector that is the same as, or similar to and/or compatible with the USB Type-C connector used in some electronic devices from Apple Inc. of Cupertino, California.

Contact/motion module 130 optionally detects contact with touch-sensitive display system 112 (in conjunction with display controller 156) and other touch-sensitive devices (e.g., a touchpad or physical click wheel). Contact/motion module 130 includes various software components for performing various operations related to detection of contact (e.g., by a finger or by a stylus), such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts or stylus contacts) or to multiple simultaneous contacts (e.g., “multitouch”/multiple finger contacts). In some embodiments, contact/motion module 130 and display controller 156 detect contact on a touchpad.

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event. Similarly, tap, swipe, drag, and other gestures are optionally detected for a stylus by detecting a particular contact pattern for the stylus.

In some embodiments, detecting a finger tap gesture depends on the length of time between detecting the finger-down event and the finger-up event, but is independent of the intensity of the finger contact between detecting the finger-down event and the finger-up event. In some embodiments, a tap gesture is detected in accordance with a determination that the length of time between the finger-down event and the finger-up event is less than a predetermined value (e.g., less than 0.1, 0.2, 0.3, 0.4 or 0.5 seconds), independent of whether the intensity of the finger contact during the tap meets a given intensity threshold (greater than a nominal contact-detection intensity threshold), such as a light press or deep press intensity threshold. Thus, a finger tap gesture can satisfy particular input criteria that do not require that the characteristic intensity of a contact satisfy a given intensity threshold in order for the particular input criteria to be met. For clarity, the finger contact in a tap gesture typically needs to satisfy a nominal contact-detection intensity threshold, below which the contact is not detected, in order for the finger-down event to be detected. A similar analysis applies to detecting a tap gesture by a stylus or other contact. In cases where the device is capable of detecting a finger or stylus contact hovering over a touch sensitive surface, the nominal contact-detection intensity threshold optionally does not correspond to physical contact between the finger or stylus and the touch sensitive surface.

The same concepts apply in an analogous manner to other types of gestures. For example, a swipe gesture, a pinch gesture, a depinch gesture, and/or a long press gesture are optionally detected based on the satisfaction of criteria that are either independent of intensities of contacts included in the gesture, or do not require that contact(s) that perform the gesture reach intensity thresholds in order to be recognized. For example, a swipe gesture is detected based on an amount of movement of one or more contacts; a pinch gesture is detected based on movement of two or more contacts towards each other; a depinch gesture is detected based on movement of two or more contacts away from each other; and a long press gesture is detected based on a duration of the contact on the touch-sensitive surface with less than a threshold amount of movement. As such, the statement that particular gesture recognition criteria do not require that the intensity of the contact(s) meet a respective intensity threshold in order for the particular gesture recognition criteria to be met means that the particular gesture recognition criteria are capable of being satisfied if the contact(s) in the gesture do not reach the respective intensity threshold, and are also capable of being satisfied in circumstances where one or more of the contacts in the gesture do reach or exceed the respective intensity threshold. In some embodiments, a tap gesture is detected based on a determination that the finger-down and finger-up event are detected within a predefined time period, without regard to whether the contact is above or below the respective intensity threshold during the predefined time period, and a swipe gesture is detected based on a determination that the contact movement is greater than a predefined magnitude, even if the contact is above the respective intensity threshold at the end of the contact movement. Even in implementations where detection of a gesture is influenced by the intensity of contacts performing the gesture (e.g., the device detects a long press more quickly when the intensity of the contact is above an intensity threshold or delays detection of a tap input when the intensity of the contact is higher), the detection of those gestures does not require that the contacts reach a particular intensity threshold so long as the criteria for recognizing the gesture can be met in circumstances where the contact does not reach the particular intensity threshold (e.g., even if the amount of time that it takes to recognize the gesture changes).

Contact intensity thresholds, duration thresholds, and movement thresholds are, in some circumstances, combined in a variety of different combinations in order to create heuristics for distinguishing two or more different gestures directed to the same input element or region so that multiple different interactions with the same input element are enabled to provide a richer set of user interactions and responses. The statement that a particular set of gesture recognition criteria do not require that the intensity of the contact(s) meet a respective intensity threshold in order for the particular gesture recognition criteria to be met does not preclude the concurrent evaluation of other intensity-dependent gesture recognition criteria to identify other gestures that do have criteria that are met when a gesture includes a contact with an intensity above the respective intensity threshold. For example, in some circumstances, first gesture recognition criteria for a first gesture—which do not require that the intensity of the contact(s) meet a respective intensity threshold in order for the first gesture recognition criteria to be met—are in competition with second gesture recognition criteria for a second gesture—which are dependent on the contact(s) reaching the respective intensity threshold. In such competitions, the gesture is, optionally, not recognized as meeting the first gesture recognition criteria for the first gesture if the second gesture recognition criteria for the second gesture are met first. For example, if a contact reaches the respective intensity threshold before the contact moves by a predefined amount of movement, a deep press gesture is detected rather than a swipe gesture. Conversely, if the contact moves by the predefined amount of movement before the contact reaches the respective intensity threshold, a swipe gesture is detected rather than a deep press gesture. Even in such circumstances, the first gesture recognition criteria for the first gesture still do not require that the intensity of the contact(s) meet a respective intensity threshold in order for the first gesture recognition criteria to be met because if the contact stayed below the respective intensity threshold until an end of the gesture (e.g., a swipe gesture with a contact that does not increase to an intensity above the respective intensity threshold), the gesture would have been recognized by the first gesture recognition criteria as a swipe gesture. As such, particular gesture recognition criteria that do not require that the intensity of the contact(s) meet a respective intensity threshold in order for the particular gesture recognition criteria to be met will (A) in some circumstances ignore the intensity of the contact with respect to the intensity threshold (e.g. for a tap gesture) and/or (B) in some circumstances still be dependent on the intensity of the contact with respect to the intensity threshold in the sense that the particular gesture recognition criteria (e.g., for a long press gesture) will fail if a competing set of intensity-dependent gesture recognition criteria (e.g., for a deep press gesture) recognize an input as corresponding to an intensity-dependent gesture before the particular gesture recognition criteria recognize a gesture corresponding to the input (e.g., for a long press gesture that is competing with a deep press gesture for recognition).

Graphics module 132 includes various known software components for rendering and displaying graphics on touch-sensitive display system 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions (e.g., instructions used by haptic feedback controller 161) to produce tactile outputs using tactile output generator(s) 167 at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing, to camera module 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which is, optionally, made up of a video player module and a music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch-sensitive display system 112, display controller 156, contact module 130, graphics module 132, and text input module 134, contacts module 137 includes executable instructions to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers and/or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch-sensitive display system 112, display controller 156, contact module 130, graphics module 132, and text input module 134, telephone module 138 includes executable instructions to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication optionally uses any of a plurality of communications standards, protocols and technologies.

In conjunction with RF circuitry 108, audio circuitry 110, speaker 111, microphone 113, touch-sensitive display system 112, display controller 156, optical sensor(s) 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch-sensitive display system 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch-sensitive display system 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, Apple Push Notification Service (APNs) or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, APNs, or IMPS).

In conjunction with RF circuitry 108, touch-sensitive display system 112, display controller 156, contact module 130, graphics module 132, text input module 134, GPS module 135, map module 154, and video and music player module 152, workout support module 142 includes executable instructions to create workouts (e.g., with time, distance, and/or calorie burning goals); communicate with workout sensors (in sports devices and smart watches); receive workout sensor data; calibrate sensors used to monitor a workout; select and play music for a workout; and display, store and transmit workout data.

In conjunction with touch-sensitive display system 112, display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, and/or delete a still image or video from memory 102.

In conjunction with touch-sensitive display system 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch-sensitive display system 112, display controller 156, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch-sensitive display system 112, display controller 156, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch-sensitive display system 112, display controller 156, contact module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch-sensitive display system 112, display controller 156, contact module 130, graphics module 132, text input module 134, and browser module 147, the widget creator module 150 includes executable instructions to create widgets (e.g., turning a user-specified portion of a web page into a widget).

In conjunction with touch-sensitive display system 112, display controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch-sensitive display system 112, display controller 156, contact module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch-sensitive display system 112, or on an external display connected wirelessly or via external port 124). In some embodiments, device 100 optionally includes the functionality of an MP3 player, such as an iPod (trademark of Apple Inc.).

In conjunction with touch-sensitive display system 112, display controller 156, contact module 130, graphics module 132, and text input module 134, notes module 153 includes executable instructions to create and manage notes, to do lists, and the like in accordance with user instructions.

In conjunction with RF circuitry 108, touch-sensitive display system 112, display controller 156, contact module 130, graphics module 132, text input module 134, GPS module 135, and browser module 147, map module 154 includes executable instructions to receive, display, modify, and store maps and data associated with maps (e.g., driving directions; data on stores and other points of interest at or near a particular location; and other location-based data) in accordance with user instructions.

In conjunction with touch-sensitive display system 112, display controller 156, contact module 130, graphics module 132, audio circuitry 110, speaker 111, RF circuitry 108, text input module 134, e-mail client module 140, and browser module 147, online video module 155 includes executable instructions that allow the user to access, browse, receive (e.g., by streaming and/or download), play back (e.g., on the touch screen 112, or on an external display connected wirelessly or via external port 124), send an e-mail with a link to a particular online video, and otherwise manage online videos in one or more file formats, such as H.264. In some embodiments, instant messaging module 141, rather than e-mail client module 140, is used to send a link to a particular online video.

Each of the above identified modules and applications correspond to a set of executable instructions for performing one or more functions described above and the methods described in this application (e.g., the computer-implemented methods and other information processing methods described herein). These modules (e.g., sets of instructions) need not be implemented as separate software programs, procedures or modules, and thus various subsets of these modules are, optionally, combined or otherwise re-arranged in various embodiments. In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating example components for event handling in accordance with some embodiments. In some embodiments, memory 102 (in FIG. 1A) or 370 (FIG. 3) includes event sorter 170 (e.g., in operating system 126) and a respective application 136-1 (e.g., any of the aforementioned applications 136, 137-155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display system 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display system 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display system 112 or a touch-sensitive surface.

In some embodiments, event monitor 171 sends requests to the peripherals interface 118 at predetermined intervals. In response, peripherals interface 118 transmits event information. In other embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch-sensitive display system 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display system 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display system 112, when a touch is detected on touch-sensitive display system 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video and music player module 152. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens. For example, mouse movement and mouse button presses, optionally coordinated with single or multiple keyboard presses or holds; contact movements such as taps, drags, scrolls, etc., on touch-pads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen (e.g., touch-sensitive display system 112, FIG. 1A) in accordance with some embodiments. The touch screen optionally displays one or more graphics within user interface (UI) 200. In these embodiments, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As described previously, menu button 204 is, optionally, used to navigate to any application 136 in a set of applications that are, optionally executed on device 100. Alternatively, in some embodiments, the menu button is implemented as a soft key in a GUI displayed on the touch-screen display, or as a system gesture such as an upward edge swipe.

In some embodiments, device 100 includes the touch-screen display, menu button 204 (sometimes called home button 204), push button 206 for powering the device on/off and locking the device, volume adjustment button(s) 208, Subscriber Identity Module (SIM) card slot 210, head set jack 212, and/or docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In some embodiments, device 100 also accepts verbal input for activation or deactivation of some functions through microphone 113. Device 100 also, optionally, includes one or more contact intensity sensors 165 for detecting intensities of contacts on touch-sensitive display system 112 and/or one or more tactile output generators 167 for generating tactile outputs for a user of device 100.

FIG. 3 is a block diagram of an example multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch-screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above identified elements in FIG. 3 are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Attention is now directed towards embodiments of user interfaces (“UI”) that are, optionally, implemented on portable multifunction device 100.

FIG. 4A illustrates an example user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) for wireless communication(s), such as cellular and Wi-Fi signals;
Time;
a Bluetooth indicator;
a Battery status indicator;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser”; and
   Icon 422 for video and music player module 152, labeled “Music”; and
Icons for other applications, such as:
   Icon 424 for IM module 141, labeled “Messages”;
   Icon 426 for calendar module 148, labeled “Calendar”;
   Icon 428 for image management module 144, labeled “Photos”;
   Icon 430 for camera module 143, labeled “Camera”;
   Icon 432 for online video module 155, labeled “Online Video”;
   Icon 434 for stocks widget 149-2, labeled “Stocks”;
   Icon 436 for map module 154, labeled “Maps”;
   Icon 438 for weather widget 149-1, labeled “Weather”;
   Icon 440 for alarm clock widget 149-4, labeled “Clock”;
   Icon 442 for workout support module 142, labeled “Workout Support”;
   Icon 444 for notes module 153, labeled “Notes”; and
   Icon 446 for a settings application or module, which provides access to settings for device 100 and its various applications 136.

It should be noted that the icon labels illustrated in FIG. 4A are merely examples. For example, other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an example user interface on a device (e.g., device 300, FIG. 3) with a touch-sensitive surface 451 (e.g., a tablet or touchpad 355, FIG. 3) that is separate from the display 450. Although many of the examples that follow will be given with reference to inputs on touch screen display 112 (where the touch sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures, etc.), it should be understood that, in some embodiments, one or more of the finger inputs are replaced with input from another input device (e.g., a mouse based input or a stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

### User Interfaces and Associated Processes

Attention is now directed towards embodiments of user interfaces (“UI”) and associated processes that may be implemented on an electronic device (or computer system more generally), such as portable multifunction device 100 or device 300, with a display, a touch-sensitive surface, (optionally) one or more tactile output generators for generating tactile outputs, and (optionally) one or more sensors to detect intensities of contacts with the touch-sensitive surface.

FIGS. 5A-5AH illustrate example user interfaces for updating status information within a region of a display area in accordance with some embodiments. The user interfaces in these figures are used to illustrate the processes described below, including the processes in FIGS. 6A-6D. For convenience of explanation, some of the embodiments will be discussed with reference to operations performed on a device with a touch-sensitive display system 112. In such embodiments, the focus selector is, optionally: a respective finger or stylus contact, a representative point corresponding to a finger or stylus contact (e.g., a centroid of a respective contact or a point associated with a respective contact), or a centroid of two or more contacts detected on the touch-sensitive display system 112. However, analogous operations are, optionally, performed on a device with a display 450 and a separate touch-sensitive surface 451 in response to detecting the contacts on the touch-sensitive surface 451 while displaying the user interfaces shown in the figures on the display 450, along with a focus selector.

FIGS. 4C1-4C2 illustrate an example state diagram 4000 of navigation between various user interfaces of the multifunction device 100 in accordance with some embodiments. In some embodiments, the multifunction device 100 displays a respective user interface from a plurality of different user interfaces, including a wake screen user interface 490 (also referred to as a coversheet user interface 496), a home screen user interface 492, a widget user interface 491, a control user interface 498, a search user interface 494, an application library user interface 497, and an application user interface 493 of a respective application (e.g., a camera application (e.g., camera application user interface 495), a flashlight application, a settings application, a messaging application (e.g., application user interface 493), a telephony application, a maps application, a browser application, or another type of application) of a plurality of applications. In some embodiments, the multifunction device utilizes various portions of the display (e.g., touch-screen display 112, display 340 associated with a touch-sensitive surface, a head-mounted display, or another type of display) to display persistent content across multiple user interfaces. For example, in some embodiments, the display includes a dynamic status region 4002 for displaying alerts, status updates, and/or current states for various subscribed and/or ongoing events, and/or for various application activities, in real-time or substantially real-time. In some embodiments, the display includes a static status region 4022 for displaying status information for one or more system functions that is relatively stable over a period of time. In some embodiments, the dynamic status region 4002 changes (e.g., expands and/or shrinks) from a region that accommodate one or more hardware elements of the multifunction device (e.g., the camera lenses, microphone, and/or speakers). As described herein, although examples below are given with touch-gestures on a touch-screen display, similar functions can be implemented with a display that is associated with a touch-sensitive surface, where a location (e.g., a location on a top edge, a bottom edge, a left edge, a right edge, a top left portion, a bottom right portion, an interior portion, and/or another portion) on the touch-sensitive surface has a corresponding location (e.g., a location on a top edge, a bottom edge, a left edge, a right edge, a top left portion, a bottom right portion, an interior portion, and/or another portion) on the display (and/or on the user interface presented on the display). Furthermore, although the examples below are given with touch-gestures on a touch-screen display, similar functions can be implemented with a display that is associated with another type of input, such as a mouse inputs, a pointer inputs, gaze inputs (e.g., gazes with time and location characteristics that are directed to various portions of the displayed user interface and/or user interface elements) in conjunction with air gesture inputs (e.g., air tap, air swipe, air pinch, pinch and hold, pinch-hold and drag, and/or another type of air gestures). As described herein, although examples below are given with touch-gestures on a touch-screen display, similar functions can be implemented with a head-mounted display that displays the user interfaces in a three-dimensional environment and that is controlled with various input devices and sensors for detecting various types of user inputs (e.g., touch gestures, inputs provided by a pointer or controller, gaze inputs, voice inputs, and/or air gestures).

As shown in FIG. 4C1, when the multifunction device 100 is initially powered on (e.g., in response to a long press or other activation input 4100 on a power button 116a (FIG. 4A) of the multifunction device 100), the multifunction device displays (4100) the wake screen user interface 490 that is the initially displayed system user interface of the multifunction device 100 when the multifunction device transitions from a power off state to a power on state.

In some embodiments, while the wake screen user interface 490 is displayed after a period of time, the multifunction device 100 optionally transitions (4101) to a low power state, where the display of the multifunction device 100 is optionally turned off, or dimmed, as illustrated by user interface 489. In some embodiments, the wake screen user interface 490 remains displayed in a dimmed, always on state, while the multifunction device 100 is in the low power state. For example, in the low power state illustrated by user interface 489, the time indication and/or date indication continues to be displayed.

In some embodiments, the multifunction device 100 transitions (4101) into the low power state (e.g., turns off the display or displays the wake screen user interface 490 in the dimmed, always-on state) in response to activation of the power button 116a of the multifunction device 100 by a user input 4101 (e.g., while displaying the wake screen user interface 490, and/or any of the other user interfaces described herein).

In some embodiments, the multifunction device transitions (e.g., automatically after a period of inactivity, and/or in response to detecting a user input activating the power button 116a) into the low power state from the normal operating state in which any of a number of user interfaces (e.g., the wake screen user interface 490, the home screen user interface 492, the application user interface 493 of a respective application, or another system and/or application user interface) may be the last displayed user interface before the transition into the low power state.

In some embodiments, when the multifunction device 100 is in the low power state, the multifunction device continues to detect inputs via one or more sensors and input devices of the multifunction device (e.g., movement of the device, touch gestures (e.g., swipe, tap, or other touch input), gaze input, air gestures, impact on the device, press on the power button, rotation of a crown, or other types of inputs). In some embodiments, in response to detecting a user input via the one or more sensors and input devices of the multifunction device, the multifunction device transitions (4100) from the low power state to the normal operating state, and displays the wake screen user interface 490 in a normal, undimmed state.

In some embodiments, when the multifunction device 100 is in the low power state illustrated in user interface 489, the multifunction device continues to detect events, such as arrival of notifications and status updates (e.g., notification for messages, incoming communication requests, and/or other application-generated events and system-generated events, and status updates for sessions, subscribed events, and/or other status changes that require the user's attention). In some embodiments, in response to detecting an event that generates an alert, a notification, and/or a status update, the multifunction device transitions from the low power state to the normal operating state, and displays the alert, notification, and/or status update on the wake screen user interface 490 in the normal, undimmed state. In some embodiments, the multifunction device automatically returns to the low power mode after a short period of time after displaying the alert, notification, and/or the status update.

In some embodiments, the wake screen user interface 490 displayed in the dimmed always-on state includes the same or substantially the same set of user interface elements as the wake screen user interface 490 displayed in the normal operating state (e.g., as opposed to the dark screen shown in FIGS. 4C1 and 4C2). In some embodiments, the wake screen user interface 490 displayed in the dimmed, always-on state has fewer user interface elements than the wake screen user interface 490 displayed in the normal operating state. For example, in some embodiments, the wake screen user interface 490 displayed in the normal operating state includes a time element 4004 showing the current time, a date element 4006 showing the current date, one or more widgets 4008 that include content from respective applications that is updated from time to time without user intervention. In some embodiments, the wake screen user interface 490 displayed in the normal operating state includes one or more application icons corresponding to respective applications, such as an application icon 4010 for the flashlight application, an application icon 4012 for the camera application, or another system-recommended or user selected application. In some embodiments, the wake screen user interface 490 displayed in the normal operating state includes one or more shortcuts for accessing respective operations in one or more system-recommended and/or user-selected applications (e.g., shortcuts to play music using a media player application, to send a quick message using the messaging application, or turn on the DND or sleep mode using a system application). In some embodiments, the wake screen user interface 490 includes the dynamic status region 4002 that displays status updates or current state of an ongoing activity for one or more applications, such as a communication session, a charging session, a running timer, music playing session, delivery updates, navigation instructions, location sharing status, and/or status updates for subscribed application and system events. In some embodiments, the wake screen user interface 490 includes the static status region 4022 that displays status for one or more system functions, such as the network connection status, battery status, location sharing status, cellular signal and carrier information, and other system status information. In some embodiments, a dynamic status update (e.g., battery charging, screen recording, location sharing, and other status updates) is displayed in the dynamic status region 4002 first, and then moved to the static status region 4022 after a period of time. In some embodiments, in a dimmed always on state, the wake screen user interface 490 omits the dynamic status region 4002, static status region 4022, the application icons 4010 and 4012, and/or the shortcuts for application and/or system operations, and optionally disables interaction with remaining user interface elements (e.g., the wallpaper, the time element 4004, the date element 4006, and/or the widgets 4008) of the wake screen user interface 490.

In some embodiments, the wake screen user interface includes one or more recently received notifications (e.g., notifications 4016, or other newly received notification(s)) that correspond to one or more applications. In some embodiments, the wake screen user interface displayed in the dimmed always on state transitions into the wake screen user interface 490 in response to detecting receipt or generation of a new notification (e.g., notification 4018, FIG. 4C2, or another one or more newly received notification(s)) In some embodiments, the notifications 4016 are grouped or coalesced based on event types and/or applications corresponding to the notifications. In some embodiments, user can interact with the notifications to dismiss the notifications, sent the notifications to notification history, and/or expand the notifications to see additional notification content (e.g., optionally after valid authentication data has been requested and/or obtained).

In some embodiments, the wake screen user interface 490 may be displayed while the multifunction device is in a locked state or an unlocked state. In some embodiments, when the wake screen user interface 490 is displayed while the multifunction device is in the locked state, a locked symbol 4020a is optionally displayed in the status region (e.g., dynamic status region 4002, static status region in the upper right corner of the display) or elsewhere (e.g., below the dynamic status region 4002, in the upper left corner, or in another portion of the display) in the wake screen user interface 490 to indicate that the multifunction device is in the locked state (e.g., shown in wake screen user interface 490 in FIG. 4C1), and that authentication data is required to dismiss the wake screen user interface 490 to navigate to the home screen user interface 492 or last-displayed application user interface. In some embodiments, the multifunction device automatically attempts to obtain authentication data via biometric scan (e.g., facial, fingerprint, voiceprint, and/or iris) when the wake screen user interface 490 is displayed (e.g., in the low power state, and/or the normal operating state), and automatically transitions into the unlocked state if valid authentication data is successfully obtained. In some embodiments, in conjunction with transitioning into the unlocked state, the multifunction device replaces the locked symbol 4020a with an unlocked symbol 4020b to indicate that the multifunction device is now in the unlocked state (e.g., shown in wake screen user interface 490 in FIG. 4C2).

In some embodiments, the multifunction device allows user interaction with the user interface elements of the wake screen user interface 490 when the wake screen user interface 490 is displayed in the normal operating mode.

For example, in some embodiments, selecting (e.g., by tapping, clicking, and/or air tapping) on a user interface element, such as one of the widgets 4008, status region 4002, notification 4018, and/or application icons 4010 or 4012, causes the multifunction device to navigate away from the wake screen user interface 490 and displays a respective user interface of the application that corresponds to the selected user interface element, or an enlarged version of the user interface element to show additional information and/or controls related to the initially displayed content in the selected user interface element. For example, as shown in FIG. 4C2, in response to a user input 4113 selecting message notification 4018, the computer system displays (4113) the application user interface 493 for the messaging application.

In another example, in some embodiments, an enhanced selection input 4112 (e.g., a touch and hold gesture, a light press input, or another type of input) on a respective user interface element, such as the time element 4004, the date element 4006, or a wallpaper of the wake screen user interface 490, causes the multifunction device to display a configuration user interface for configuring one or more aspects of the wake screen user interface 490 (e.g., selecting a wallpaper, configuring a color or font scheme of the user interface element, configuring how to layout the different elements of the wake screen user interface, configuring additional wake screen, selecting a previously configured wake screen, and view additional customization options for the wake screen user interface). In some embodiments, configuration of the wake screen user interface 490 is partially applied to the home screen user interface 492, and vice versa.

In some embodiments, an enhanced selection input (e.g., a touch and hold gesture, a light press input, or another type of input) on the flashlight application icon 4010 or the camera application icon 4012 causes the multifunction device to activate the flashlight of the multifunction device or display the camera user interface 495 of the camera application. For example, in response to detecting selection input 4104a on the camera application icon 4012 in the wake screen user interface 490, the multifunction device activates the camera application and displays (4104a) the camera application UI 495 (e.g., as shown in FIG. 4C1).

In some embodiments, if the multifunction device detects user interaction with the user interface elements shown in the wake screen user interface 490 and determines that the wake screen user interface is in the locked state, the multifunction device attempts to obtain authentication data from the user by displaying an authentication user interface (e.g., a passcode entry interface, a password entry user interface, and/or a biometric scan user interface). The multifunction device proceeds to navigate away from the wake screen user interface 490 and performs the operation in accordance with the user's interaction after valid authentication data has been obtained from the user.

In some embodiments, in addition to performing operations (e.g., navigating to application user interfaces, displaying expanded versions of user interface elements that show additional information, and/or displaying configuration options for a respective user interface element or the wake screen user interface), the multifunction device allows the user to navigate from the wake screen user interface 490 to other user interfaces (optionally, after valid authentication data has been obtained) in response to navigation inputs (e.g., swipe gestures or other types of navigation inputs that are directed to regions of the wake screen user interface that are not occupied by a user interface element, and/or regions of the wake screen user interface that are occupied by user interface element (e.g., widgets, application icons, and/or time elements) that do not respond to swipe gestures or said other types of navigation inputs).

For example, in some embodiments, an upward swipe gesture 4105 that starts from the bottom edge of the wake screen user interface 490 causes (4105) the multifunction device to navigate away from the wake screen user interface 490 and display the home screen user interface 492 or the last-displayed application user interface (optionally, after requesting and obtaining valid authentication data).

In some embodiments, the upward swipe gesture 4105 is a representative example of a home gesture or dismissal gesture (e.g., other examples include upward swipe gestures 4103a, 4103c, 4103d, 4103c, 4110a, and 4111a) that causes the multifunction device to dismiss the currently displayed user interface (e.g., the wake screen user interface 490, an application user interface (e.g., camera user interface 495, messages user interface 493, or another application user interface), the control user interface 498, the search user interface 494, the application library user interface 497, or the home screen configuration user interface) and navigate to the home screen user interface 492 or a last-displayed user interface (e.g., the wake screen user interface 490, the wake screen configuration user interface, the search user interface 494, an application user interface, or the home screen user interface 492).

In some embodiments, a downward swipe from a top edge (e.g., the central portion of the top edge, or any portion of the top edge) or an interior region of the wake screen user interface 490 (e.g., downward swipe 4106a, or another downward swipe) causes (4106a) the multifunction device to display the search user interface 494 that includes a search input region 4030 and one or more applications icons 4032 for recommended applications (e.g., recently used applications, and/or relevant applications based on the current context), as shown in FIG. 4C1. In some embodiments, in response to detecting a search input in the search input region 4030, the multifunction device retrieves and displays search results that include relevant application content (e.g., messages, notes, media files, and/or documents) from the different applications that are installed on the multifunction device, relevant applications (e.g., applications that are installed on the multifunction device and/or applications that are available in the app store), relevant webpages (e.g., bookmarked webpages and/or webpages newly retrieved from the Internet), and/or search results from other sources (e.g., news, social media platforms, and/or reference websites). In some embodiments, different sets of search results are provided depending on the locked and unlocked state of the multifunction device, and more details or additional search results may be displayed if the multifunction device is in the unlocked state when the search is performed. In some embodiments, the multifunction device attempts to obtain valid authentication data in response to receiving the search input, and displays different sets of search results depending on whether valid authentication data is obtained. In some embodiments, an upward swipe gesture 4103d that starts from the bottom edge of the search user interface (or another type of dismissal input) causes (4103d) the multifunction device to dismiss the search user interface 494 and redisplays the wake screen user interface 490 (e.g., since the wake screen user interface was the last displayed user interface), as shown in FIG. 4C1. In some embodiments, in response to a downward swipe 4106b from an interior region of the home screen user interface 492 causes (4106b) the multifunction device to display the search user interface 494; and in response to a subsequent upward swipe gesture 4103d from the bottom edge of the search user interface 494, the home screen user interface 492 is (4103d) redisplayed (e.g., since the home screen user interface was the last displayed user interface), as shown in FIG. 4C1.

In some embodiments, as shown in FIG. 4C1, a rightward swipe gesture 4102a that starts from a left edge or interior region of the wake screen user interface 490 causes (4102a) the multifunction device to navigate from the wake screen user interface 490 to a widget user interface 491 (or another system user interface other than the home screen user interface, such as a control user interface, a search user interface, or a notification history user interface). In some embodiments, the widget user interface 491 includes a plurality of widgets 4026 (e.g., including widget 4026a, widget 4026b and widget 4026c) that are automatically selected by the operating system and/or selected by the user for inclusion in the widget user interface 491. In some embodiments, the widgets 4026 displayed in the widget user interface 491 have form factors that are larger than the widgets 4008 displayed under the time element 4004 in the wake screen user interface 490. In some embodiments, the widgets 4026 displayed in the widget user interface 491 and the widgets 4008 displayed in the wake screen user interface 490 are independently selected and/or configured from each other. In some embodiments, the widgets 4026 in the widget user interface 491 include content from their respective applications and the content is automatically updated from time to time as the updates to the content becomes available in the respective applications. In some embodiments, selection of a respective widget (e.g., tapping on the respective widget, or providing other selection input directed to the respective widget) in the widget user interface causes the multifunction device to navigate away from the widget user interface 491 and displays a user interface of the application that corresponds to the respective widget (optionally, after valid authentication data is requested and/or obtained).

In some embodiments, an upward swipe gesture 4103a that starts from the bottom edge of the widget user interface 491 and/or a leftward swipe gesture 4103b that starts from the right edge or the interior region of the widget user interface 491 causes (4103a-1/4103b-1) the multifunction device to dismiss the widget user interface 491 and redisplay the wake screen user interface 490, as shown in FIG. 4C1.

In some embodiments, a leftward swipe gesture 4104b that starts from the right edge or interior portion of the wake screen user interface 490 causes (4104b) the multifunction device to navigate from the wake screen user interface 490 to a camera user interface 495 of the camera application. In some embodiments, access to the photo library through the camera application is restricted in the camera user interface 495 unless valid authentication data has been obtained. In some embodiments, as shown in FIG. 4C1, an upward swipe gesture 4103c that starts from the bottom edge of the camera user interface 495 or another dismissal input causes (4103c) the multifunction device to navigate away from the camera user interface 495 and redisplay the wake screen user interface 490 (e.g., since the wake screen user interface 490 is the last displayed user interface prior to displaying the camera user interface 495).

In some embodiments, a downward swipe gesture 4109a that starts from the right portion of the top edge of the wake screen user interface (e.g., as illustrated in FIG. 4C2) causes (4109a) the multifunction device to display the control user interface 498 overlaying or replacing display of the wake screen user interface 490. In some embodiments, the control user interface 498 includes status information for one or more static status indicators displayed in the static status region 4022, and respective sets of controls 4028 (e.g., including control 4028a, control 4028b, and control 4028c) for various system functions, such as network connections (Wi-Fi, cellular data, airplane mode, Bluetooth, and other connection types), media playback controls, display controls (e.g., display brightness, color temperature, night shift, true tone, and dark mode controls), audio controls (e.g., volume, and/or mute/unmute controls, focus mode controls (e.g., DND, work, study, sleep, and other modes in which generation of alerts and notifications are moderated based on context and configurations, and application icons (e.g., flashlight, timer, calculator, camera, screen recording, and/or other user-selected or system recommended applications))). In some embodiments, an upward swipe gesture 4110a that starts from the bottom edge of the control user interface 498 (or another dismissal input) causes the multifunction device to dismiss the control user interface 498 and redisplay (4110a-1) the wake screen user interface 490 (e.g., since the wake screen user interface 490 is the last displayed user interface prior to displaying the control user interface 498).

In some embodiments, an upward swipe gesture 4107 that starts from the interior region of the wake screen user interface 490 and/or an upward swipe gesture that starts from the interior of the coversheet user interface 496 (e.g., optionally, when there are no unread notifications displayed in the coversheet user interface) causes (4107) the multifunction device to display the notification history user interface that includes a plurality of previously saved notifications and notifications that have been sent directly to notification history without first being displayed on the wake screen user interface 490. In some embodiments, the notification history user interface can be scrolled to reveal additional notifications in response to an upward swipe gesture 4118 directed to the notification history in the wake screen user interface 490 and/or the coversheet user interface 496. In some embodiments, the notification history is displayed as part of the wake screen user interface 490 and/or coversheet user interface 496, and a downward swipe gesture 4103f that is directed to the interior portion of the notification history causes the notification history to cease to be displayed and causes the wake screen user interface 490 and/or coversheet user interface 496 to be redisplayed without the notification history.

As described above, after navigating from the wake screen user interface 490 to a respective user interface other than the home screen user interface (e.g., in response to a swipe gesture in the downward, leftward, or rightward directions), an upward swipe gesture 4103 (e.g., 4103a, and 4103c through 4103f) that starts from a bottom edge of the respective user interface (e.g., an upward swipe gesture that starts from the bottom edge of the touch-sensitive display that displays a respective user interface in full screen mode, or an upward swipe gesture that starts from the bottom edge of a touch-sensitive surface that corresponds to the display that displays the respective user interface) causes the multifunction device to dismiss the respective user interface and returns to the wake screen user interface 490. In contrast, an upward swipe gesture 4105 that starts from the bottom edge of the wake screen user interface 490 causes (4105) the multifunction device to navigate away from the wake screen user interface 490 and displays the home screen user interface 492, and another upward swipe gesture that starts from the bottom edge of the home screen user interface 492 does not cause the multifunction device to dismiss the home screen user interface 492 and return to the wake screen user interface 490. In other words, once the navigation from the wake screen user interface 490 to the home screen user interface 492 is completed, the multifunction device is no longer in the restricted state, and access to the application icons displayed on the home screen user interface 492 and access to the content and functions of the computer system are unrestricted to the user. The upward swipe gesture that starts from the bottom edge of the currently displayed user interface is a representative example of a dismissal input that dismisses the currently displayed user interface and redisplays the last displayed user interface. The upward swipe gesture that starts from the bottom edge of the currently displayed user interface is also a representative example of a home gesture that dismisses the currently displayed user interface and displays the home screen user interface (e.g., irrespective of whether the home screen user interface was the last displayed user interface prior to displaying the currently displayed user interface).

As shown in FIG. 4C2, once the multifunction device navigates away from the wake screen user interface 490 and displays the home screen user interface 492, the user can access the functions and applications of the multifunction device without restriction. For example, in some embodiments, the home screen user interface 492 includes multiple pages, and a respective page of the home screen user interface includes a respective set of application icons and/or widgets corresponding to different applications, and user selection of (e.g., by tapping on, clicking on, or otherwise selecting) a respective widget or application icon causes the multifunction device to display an application user interface of the application that corresponds to the respective widget or application icon.

In some embodiments, the home screen user interface 492 displays a search affordance 4034 (e.g., as illustrated in FIG. 4C1), and a tap on the search affordance 4034 causes the search user interface 494 described above to be displayed overlaying the home screen user interface 492. In some embodiments, in response to detecting an upward swipe gesture 4103d that starts from the bottom edge of the search user interface (or another dismissal input), the multifunction device dismisses the search user interface 494 and redisplays (4103d) the home screen user interface 492 (e.g., not the wake screen user interface 490, as the upward edge swipe gesture dismisses the currently displayed user interface and redisplays the last displayed system user interface).

In some embodiments, as shown in FIG. 4C1, a rightward swipe gesture 4102b that starts from the left edge of the first page of the home screen user interface 492 causes (4102b) the multifunction device to display the widget user interface 491 described above. In some embodiments, a leftward swipe gesture (e.g., gesture 4103b, or another leftward swipe gesture) that starts from the right edge or the interior region of the widget user interface or an upward swipe gesture (e.g., gesture 4103a, or another upward swipe gesture) that starts from the bottom edge of the widget user interface 491 causes (4103a-2/4103b-2) the multifunction device to navigate away from the widget user interface 491 and redisplays the first page of the home screen user interface 492 (e.g., when the home screen user interface 492 was the last displayed user interface prior to displaying the widget user interface 491).

In some embodiments, consecutive leftward swipe gestures 4116 on the home screen user interface 492, as shown in FIG. 4C2, navigates through consecutive pages of the home screen user interface 492 until the application library user interface 497 is (4116) displayed. In some embodiments, the application library user interface 497 displays application icons from multiple pages of the home screen user interface grouped into different categories. In some embodiments, the application library user interface 497 includes a search user interface element 4036 that accepts search criteria (e.g., keywords, image, and/or other search criteria) and returns application icons for relevant applications (e.g., applications that are stored on the multifunction device and/or available in the app store) as search results. In some embodiments, user selection of (e.g., by a tap input, a click input, or another type of selection input) on an application icon in the search results and/or in the application library causes the multifunction device to display the application user interface of the application that corresponds to the selected application icon.

In some embodiments, a downward swipe gesture 4109c that starts from the right portion of the top edge of the application library user interface 497 causes display of the control user interface 498 as described above. In some embodiments, an upward swipe gesture (e.g., upward swipe gesture 4110a, or another upward swipe gesture) that starts from the bottom edge of the control user interface 498 or another dismissal input causes the multifunction device to dismiss the control user interface 498 and redisplay the application library user interface 497 (e.g., since the application library user interface is the last displayed user interface before the display of the control user interface) (e.g., or redisplay another user interface (e.g., redisplay (4110a-1) the wake screen user interface 490 (e.g., if control user interface 498 is displayed in response to swipe gesture 4109a), redisplay (4110a-3) the home screen user interface 492 (e.g., if the control user interface is displayed in response to a downward swipe from the top right portion of the top edge of the display), or redisplay (4110a-2) the application user interface (e.g., if the control user interface is displayed in response to the downward swipe 4109b) that was the last displayed user interface prior to displaying the control user interface).

In some embodiments, a rightward swipe gesture 4115 that starts from the interior region or the left edge of the application library user interface 497 or an upward swipe gesture that starts from the bottom edge of the application library user interface 497 causes (4115) the multifunction device to dismiss the application library user interface 497 and redisplays the last page of the home screen user interface 492.

In some embodiments, a downward swipe gesture 4114 that starts from the interior region of the application library user interface 497 causes the multifunction device to display the application icons for applications stored on the multifunction device in a scrollable list (e.g., according to chronological or alphabetical order).

In some embodiments, an upward swipe gesture that starts from the bottom edge of the home screen user interface causes the multifunction device to display the first page of the home screen user interface 492 or display the multitasking user interface 488 (also referred to an application switcher user interface). In some embodiments, different criteria (e.g., criteria based on the speed, direction, duration, distance, intensity, and/or other characteristics) are used to determine whether to navigate to the first page of the home screen user interface 492 or to the multitasking user interface 488 in response to detecting the upward swipe gesture that starts from the bottom edge of the home screen user interface. For example, in some embodiments, a short flick and a slow and long swipe cause the multifunction device to navigate to the first page of the home screen user interface 492, while a slow and medium length swipe causes the multifunction device to display the multitasking user interface 488. In some embodiments, a navigation gesture is dynamically evaluated before the termination of the gesture is detected, and therefore, the estimated destination user interface of the navigation gesture continues to change and visual feedback regarding the estimated destination user interface continues to be provided to guide the user to conclude the gesture when the desired destination user interface is indicated by the visual feedback. In some embodiments, in response to a user input 4117 at a portion of the multitasking user interface 488 that does not correspond to an application, a last displayed user interface that is displayed before displaying the multitasking user interface 488 is displayed (e.g., home screen user interface 492 is displayed when the multitasking user interface 488 is displayed in response to user input 4111b).

In some embodiments, a reconfiguration mode of the home screen user interface 492 is displayed in which application icons and/or widgets can be repositioned in, removed from, or added to the different pages of the home screen user interface 492. In some embodiments, a touch and hold gesture or another enhanced selection input directed to the home screen user interface 492 for a respective threshold amount of time or another enhanced selection input directed to the home screen user interface 492 cause the multifunction device to display the home screen user interface 492 in the configuration mode. In some embodiments, selection of the search affordance 4034 in the home screen user interface 492 while the home screen user interface 492 is in the reconfiguration mode causes the multifunction device to display a page editing user interface for the home screen user interface in which pages of the home screen user interface may be reordered, deleted, hidden, or created. In some embodiments, a tap input on the home screen user interface in the reconfiguration mode, causes the home screen user interface to exit the reconfiguration mode. In some embodiments, a tap input on unoccupied portion of the page editing user interface causes the multifunction device to exist the page editing user interface and redisplays the home screen user interface in the reconfiguration mode. Another tap on the home screen user interface causes the home screen user interface to exit the reconfiguration mode and be redisplayed in the normal mode.

In some embodiments, while displaying the home screen user interface 492, a downward swipe gesture 4108a that starts from the top edge of the home screen user interface 492 causes (4108a) the multifunction device to cover the home screen user interface 492 with the coversheet user interface 496 (also referred to as the wake screen user interface 490 if the user interface is displayed when transitioning from a normal mode to a low-power mode, and/or vice versa (e.g., due to inactivity, due to activation of the power button, and/or due to user input that corresponds to a request to wake or lock the device)) and the access to the home screen user interface is temporarily restricted by the coversheet user interface 496. In some embodiments, while the coversheet user interface 496 is displayed, an upward swipe gesture 4103e that starts from the bottom edge of the coversheet user interface 496 dismisses (4103e) the coversheet user interface 496 and redisplays the home screen user interface 492 (e.g., since the home screen user interface is the last displayed user interface). In some embodiments, the coversheet user interface has responses to user inputs in a manner analogous to those described with respect to the wake screen user interface 490.

In some embodiments, an application user interface of a respective application can be displayed in response to user inputs in a number of scenarios, such as tapping on a widget displayed in the home screen user interface or the widget user interface; tapping on an application icon displayed in the home screen, in the widget user interface, in the search result or recommended application portion of the search user interface, in the application library user interface or in the search results provided in a search in the application library user interface; tapping on a notification on the wake screen user interface or in the notification history; tapping on a representation of an application in the multitasking user interface; or selecting a link to an application in a user interface of another application (e.g., a link to a document, a link to a phone number, a link to a message, a link to an image, and other types of links). In some embodiments, a user interface of a single application is displayed in a full-screen mode. In some embodiments, user interfaces of two or more applications are displayed in a concurrent-display configuration, such as in a side-by-side display configuration where the user interfaces of the applications are displayed adjacent to one another to fit within the display, or in an overlay display configuration where the user interface of a first application is displayed in the full-screen mode while the user interfaces of other applications are overlaid on portion(s) of the user interface of the first application (e.g., in a single stack or separately on different portions).

In some embodiments, while displaying a user interface of an application, an upward swipe gesture (e.g., upward swipe gesture 4111a, or another upward swipe gesture) that starts from the bottom edge of the application user interface (e.g., messages user interface 493, or another user interface of an application) or another dismissal input or home gesture causes (4111a-1, or 4111a-2) the multifunction device to dismiss the currently displayed application user interface, and display either the home screen user interface (e.g., shown as transition 4111a-1) or the multitasking user interface (e.g., shown as transition 4111a-1) depending on the characteristics of the upward swipe gesture. In some embodiments, while displaying home screen user interface 492, an upward swipe gesture 4111b that starts from the bottom edge of the home screen user interface causes (4111b) the multifunction device to dismiss the currently displayed home screen user interface 492, and display the multitasking user interface 488.

In some embodiments, a horizontal swipe gesture in the leftward and/or rightward direction that is performed within a bottom portion of the application use interface(s) causes the multifunction device to switch to another previously displayed application user interface of a different application. In some embodiments, the same swipe gesture that starts from the bottom portion of a respective application user interface is continuously evaluated, to determine and update an estimated destination user interface among the multitasking user interface 488, the home screen user interface 492, or a user interface of a previously displayed application, based on the characteristics of the swipe gesture (e.g., location, speed, direction, and/or change in one or more of the above), and a final destination user interface is displayed in accordance with the estimated destination user interface at the termination of the swipe gesture (e.g., lift off of the contact, reduction in intensity of the contact, a pause in movement, and/or another type of change in the input).

In some embodiments, while displaying an application user interface of a respective application (or displaying application user interfaces of multiple applications in a concurrent-display configuration), a downward swipe gesture 4108b that starts from the top edge of the application user interface(s) causes (4108b) the multifunction device to display the coversheet user interface 496 (FIG. 4C1) (or the wake screen user interface 490 in FIG. 4C2) over the application user interface(s). The multifunction device dismisses the coversheet user interface 496 (or the wake screen user interface 490) and redisplays the application user interface(s) in response to an upward swipe gesture that starts from the bottom edge of the coversheet user interface (or another dismissal input).

In some embodiments, as shown in FIG. 4C2, a downward swipe gesture 4109b that starts from the static status region 4022 on the display cause (4109b) the multifunction device to display the control user interface 498 over the application user interface(s), and an upward swipe gesture 4110a that starts from the bottom edge of the control user interface 498 (or another dismissal input) dismisses the control user interface 498 and causes (4110a-2) the application user interfaces to be redisplayed (e.g., or the last displayed user interface that is displayed before displaying the control user interface 498).

In some embodiments, rotation of the display causes the multifunction device to display a different version of the currently displayed user interface (e.g., application user interface, home screen user interface, wake screen user interface, control user interface, notification user interface, widget user interface, application library user interface, and other user interfaces described with respect to FIGS. 4C1-4C2) that have a differently layout (e.g., landscape version vs. portrait version). In some embodiments, rotation of the display has no effect on the orientation of the respective user interface that is currently displayed.

The above description of the navigation between user interfaces and exact appearances and components of the various user interfaces are merely illustrative and may be implemented with variations in various embodiments described herein. In addition, the transitions between pairs of user interfaces illustrated in FIGS. 4C1-4C2 are only a subset of all transitions that are possible between different pairs of user interfaces illustrated in FIGS. 4C1-4C2, and a transition to a respective user interface may be possible from any of multiple other user interfaces, in accordance with a respective user input of a same type, directed to a same interaction region of the display, and/or in accordance with a different type of input or directed to a different interactive region, in accordance with various embodiments.

### User Interfaces and Associated Processes

Attention is now directed towards embodiments of user interfaces (“UI”) and associated processes that may be implemented on an electronic device (or computer system more generally), such as portable multifunction device 100 or device 300, with a display, a touch-sensitive surface, (optionally) one or more tactile output generators for generating tactile outputs, and (optionally) one or more sensors to detect intensities of contacts with the touch-sensitive surface.

FIGS. 5A-5AH illustrate example user interfaces for updating status information within a region of a display area in accordance with some embodiments. FIGS. 6A-6E illustrate a flow diagram of updating status information within a region of a display area in accordance with some embodiments. The user interfaces in these figures are used to illustrate the processes described below, including the processes in FIGS. 6A-6E. For convenience of explanation, some of the embodiments will be discussed with reference to operations performed on a device with a touch-sensitive display system 112.

FIG. 5A illustrates a device 100 that includes a display having a display area. In some embodiments, the device 100 displays, in the display area, a user interface 502 (e.g., a home screen user interface 492, another system user interface or an application user interface). In some embodiments, the user interface 502 is displayed concurrently with display of one or more status icons. For example, device 100 displays a time indication 504 and/or a date indication 506 in a status region of the display area of device 100. In some embodiments, the status region further includes one or more status icons, including (e.g., cellular) wireless signal icon 508, Wi-Fi signal icon 510 and/or battery icon 512. In some embodiments, each of the one or more status icons is automatically displayed at a respective position within the status region.

In some embodiments, the status region of the display area is an upper portion, such as a status bar, along the top edge of the display area (e.g., regardless of a current orientation of device 100, as described below with reference to FIG. 5AA). For example, as illustrated in FIG. 5A, while the device 100 is in a position corresponding to a first orientation (e.g., a landscape orientation or a portrait orientation), the status region corresponds to a status bar along the horizontal top border of the display area.

FIG. 5A illustrates device 100 displaying an indication 514 of an incoming call. In some embodiments, indication 514 is automatically, without user input, displayed in accordance with device 100 receiving a call (e.g., an audio call, a video call, or another invitation for a communication session). In some embodiments, an indication is provided for other types of alerts, other than receiving a call, as described below.

In some embodiments, indication 514 is displayed overlaying the home screen user interface 492, optionally outside of (e.g., below and/or adjacent to) the status region. In some embodiments, indication 514 includes one or more user-selectable controls for the user to interact with indication 514. For example, the one or more user-selectable controls includes a control for answering the call and a control for declining the call.

In some embodiments, in response to detecting user input 516 selecting the control for answering the call that is displayed within indication 514, device 100 initiates a communication session for the call. In some embodiments, while the communication session for the call is ongoing, device 100 displays status icon 518 (e.g., including status icons 518a through 518j) for the communication session, as illustrated in FIG. 5B. In some embodiments, status icon 518 is displayed in the status region. In some embodiments, status icon 518 is displayed in the status region at a position that does not overlap or cause one or more other status icons in the status region to move positions within the status region. For example, time indication 504 and date indication 506 continue to be displayed at their respective positions in the status region, while status icon 518a for the communication session is displayed proximate to (e.g., to the right of, or on another side of) date indication 506.

In some embodiments, status icon 518a is displayed with a size that fits within the status region (e.g., with a same height as the other status icons).

In some embodiments, status icon 518a displays information about the communication session. For example, status icon 518a indicates that the communication session is a telephone call, as illustrated by the telephone icon, and indicates a duration of the telephone call (e.g., “00:02”). In some embodiments, status icon 518 is updated over time; for example, as the duration of the telephone call changes, the status icon 518 is updated to indicate the current duration of the telephone call.

In some embodiments, status icon 518 continues to be displayed in the status region while the communication session is ongoing. For example, status icon 518 is displayed during the telephone call, and automatically ceases to be displayed in accordance with a determination that the communication session is no longer active (e.g., in response to detecting an end of the communication session, status icon 518 is no longer displayed).

FIG. 5C illustrates that, while status icon 518b is displayed, device 100 detects a communication signal, such as a near-field communication (NFC) signal from NFC reader 520, a Bluetooth signal, a device-to-device wireless signal, or other communication signal. In response to detecting the communication signal, indication 522 corresponding to the detected communication signal is displayed in the display area of device 100, as illustrated in FIG. 5D. In some embodiments, a software application of device 100 is associated with the detected communication signal, such as a payment application or other stored identifier, such that device 100 is enabled to communicate with NFC reader 520, and indication 522 corresponding to the detected communication signal is associated with the respective software application.

In some embodiments, as illustrated in FIG. 5D, indication 522 is displayed proximate to and/or outside of the status region. In some embodiments, status icon 518c for the ongoing communication session continues to be displayed, while the communication session is ongoing, in the status region concurrently with indication 522.

In some embodiments, indication 522 for the communication signal is updated to status icon 524 in accordance with one or more minimizing criteria. For example, the one or more minimizing criteria that cause indication 522 to decrease in size (e.g., minimize, shrink, animate, and/or transition to) and/or be replaced with status icon 524 include a criterion that is met in accordance with a determination that a threshold amount of time has passed (e.g., after 5 seconds, 10 seconds, 2 minutes, or another amount of time has passed) since indication 522 has been displayed. In some embodiments, in accordance with the one or more minimizing criteria being satisfied, indication 522 is automatically, without user input, replaced with status icon 524 to indicate the communication signal continues to be detected. In some embodiments, the one or more minimizing criteria include a criterion that is met in accordance with detecting a user input that is directed outside of indication 522. For example, in response to a user input (e.g., a tap input, a swipe input, or other type of input) detected at the device 100 (e.g., a user input directed to the display area outside of the status region or to the status region or to indication 522), indication 522 is displayed within the status region, as illustrated in FIGS. 5E-5F, while the communication signal remains detected. In some embodiments, indication 522 and/or status icon 524 continue to be displayed while the communication signal is detected, and optionally for at least a threshold amount of time after (e.g., 5 seconds after, 30 seconds after, 1 minute after, or another amount of time after) the communication signal is no longer detected by device 100.

FIG. 5D illustrates detecting a user input 521 directed to an application icon to open a respective application associated with the application icon. For example, user input 521 selects a music application icon. In some embodiments, in response to detecting user input 521, device 100 displays a user interface 526 for the music application that corresponds to the selected application icon, as illustrated in FIG. 5E.

In some embodiments, in response to detecting user input 521 (e.g., and/or in accordance with a determination that one or more minimizing criteria are met), indication 522 is updated to be displayed within the status region as status icon 524. For example, in FIG. 5E, status icon 524 is displayed, concurrently with status icon 518d for the ongoing communication session, in the status region. In some embodiments, indication 522 is no longer displayed as overlapping with the user interface displayed in the display area outside of the status region, so as to not obscure the view of user interface 526 for the music application.

In some embodiments, an input that is detected as being directed to a portion of the display area that is outside of indication 522 causes device 100 to cease display of indication 522 and, optionally, to replace indication 522 with a minimized indication (e.g., status icon 524 or another minimized indication) while the communication signal continues to be detected.

FIG. 5E illustrates user input 528 selecting a “Listen Now” button displayed in user interface 526 for the music application. In some embodiments, in response to user input 528, a music session is initiated at device 100. In some embodiments, the music session corresponds to ongoing playback of media content at device 100. In some embodiments, user input 530 corresponding to a request to dismiss user interface 526 (e.g., a request to view a system user interface, such as home screen user interface 502) is then detected. In some embodiments, as described with reference to FIGS. 4C, user input 530 is a swipe gesture or other type of user input.

In some embodiments, in response to detecting user input 530, device 100 displays home screen user interface 502, as illustrated in FIG. 5F. In some embodiments, while the music session that was initiated in response to user input 528 is ongoing, status icon 532a for the music session is displayed in the status region. As illustrated in FIG. 5F, status icon 532a for the music session is displayed concurrently with status icon 518e for the communication session and status icon 524 for the communication signal.

FIG. 5F further illustrates user input 534 corresponding to a request to view a different page of home screen user interface 502. For example, user input 534 is a swipe input to view a second page of home screen user interface 502b, as illustrated in FIG. 5G, where the second page of home screen user interface 502b includes a different set of application icons and/or widgets as compared to a first page of home screen user interface 502 (e.g., FIG. 5F).

As illustrated in FIG. 5G, status icons for ongoing sessions are maintained in the status region while displaying the second page of home screen user interface 502b. For example, the user is enabled to navigate to various system user interfaces (e.g., pages of the home screen user interface, a wake screen user interface, a control center user interface, a widgets user interface, or other system user interfaces described with reference to FIGS. 4C1-4C2) while the status icons continue to be displayed in the status region. For example, in FIG. 5G, the music session and the communication session are ongoing, and thus status icon 532a for the music session and status icon 518f for the communication session continue to be displayed in FIG. 5G (e.g., in the status region). In some embodiments, because NFC reader 520 is no longer detected, status icon 524 for the communication signal indicating the detection of NFC reader 520 ceases to be displayed.

FIG. 5G illustrates a user input 536 corresponding to a request to turn off, or dim, the display of device 100. For example, user input 536 is a user input on a physical button, such as a power button, as described with reference to user input 4101 (FIG. 4C1).

In some embodiments, in response to detecting a request to wake device 100 (e.g., after the display of device 100 is dimmed or turned off or transitioned to a low-power state), wake screen user interface 503 is displayed. In some embodiments, wake screen user interface 503 is wake screen user interface 490 described with reference to FIG. 4C1. In some embodiments, wake screen user interface 503 is displayed concurrently with the status region, including display of status icon 518g for the ongoing communication session. In some embodiments, one or more status icons for one or more types of sessions are displayed on wake screen user interface 503 outside of the status region. For example, in FIG. 5H, platter 532b is displayed for the music session without displaying status icon 532a for the music session in the status region. For example, the music session is ongoing, but status icon 532a is replaced (e.g., in response to detecting a user input directed to status icon 532a and/or in response to detecting the occurrence of an event related to the session (e.g., as described with reference to FIG. 5M)) with a different indication, such as platter 532b, with information about the session. In some embodiments, platter 532b is displayed with a larger size and/or with additional information about the session as compared to the status icon for the session that is displayed in the status region. In some embodiments, other types of sessions associated with other applications (e.g., other than the music application), are displayed with a platter or other indication (e.g., optionally displayed outside of the status region) on the wake screen user interface 503. In some embodiments, the status icons for one or more types of sessions are maintained in the status region without being displayed as a distinct indication on wake screen user interface 503.

In some embodiments, in response to detecting user input 538 corresponding to a request to dismiss wake screen user interface 503, wake screen user interface 503 is replaced with another user interface, such as the user interface that was previously displayed before and/or while detecting the user input 536 (e.g., the second page of home screen user interface 502b or another user interface).

FIG. 5I illustrates detecting the user input 540 corresponding to a request to display the first page of home screen user interface 502. For example, in response to detecting user input 540, home screen user interface 502 is displayed, as illustrated in FIG. 5J. As illustrated in FIGS. 51-5J, in some embodiments, as the user navigates between different pages of the home screen user interface, other system user interfaces, and/or application user interfaces, the status region continues to display indications (e.g., status icons, platters, and/or other user interface objects) for current sessions. For example, in FIG. 5I, status icon 532a for the music session is displayed while the music session is ongoing, and status icon 518h for the communication session is displayed for the ongoing communication session. As illustrated in FIG. 5J, the status icon 532a continues to be displayed for the music session and the status icon 518i is displayed for the communication session, where status icon 518i is optionally updated (e.g., from status icon 518h) to display the current length of the ongoing communication session and/or other information for the communication session.

FIG. 5J illustrates user input 542 detected as being directed to status icon 518i for the communication session. In some embodiments, in response to user input 542, status icon 518i is replaced with an expanded indication 518j, as illustrated in FIG. 5K. In some embodiments, the expanded indication 518j includes one or more additional control options that are not displayed in status icon 518i. For example, expanded indication 518j includes buttons for controlling the communication session, such as a mute button for muting audio being provided to the communication session based on a microphone that is in communication with device 100, a dial pad button for entering a phone number to initiate a call, a speaker button for changing a volume of audio from the communication session or changing which audio output device is being used to output audio from the communication session, a video button for enabling or disabling video being provided to the communication session by device 100, and/or a hang up button for ending the communication session. In some embodiments, expanded indication 518j is displayed via an animated transition from status icon 518i to expanded indication 518j. In some embodiments, the animated transition includes gradually, over a period of time, increasing a size of status icon 518i and/or changing a position of status icon 518i, for example, to be displayed, at least partially, outside of the status region. In some embodiments, expanded indication 518j is displayed as overlapping with the status region (e.g., optionally is displayed on top of time indication 504, date indication 506 and/or status icon 532a). In some embodiments, expanded indication 518j is displayed below the status region and overlaps with the display area outside of the status region (e.g., including occluding a portion of home screen user interface 502 and/or another application user interface that is displayed in the display area).

FIG. 5K illustrates user input 544 directed to the hang up button displayed in expanded indication 518j. In response to the user input 544, the communication session ends and the indication for the communication session ceases to be displayed. For example, status icon 518i and/or the expanded indication 518j cease to be displayed.

FIG. 5L illustrates that, while the music session is ongoing, status icon 532a continues to be displayed. FIG. 5L further illustrates detecting user input 546 directed to a clock application icon 446 to open a clock application. In some embodiments, the clock application includes a timer user interface 550 for setting a timer, as illustrated in FIG. 5M.

FIG. 5M illustrates expanded indication 532c for the music session. In some embodiments, expanded indication 532c is automatically displayed, without user input, in accordance with a determination that a respective event for the music session has occurred. For example, the respective event is a change in the currently playing song (e.g., from Song A to Song B). In some embodiments, different applications are associated with one or more respective events such that, in response to the respective event occurring, the indication for the session associated with the respective application is automatically updated (e.g., and expanded) to display an alert associated with the respective event. For example, in FIG. 5M, expanded indication 532c for the music session includes an indication of the newly playing song, Song B, and includes one or more controls for controlling the music session that were not displayed in status icon 532a (e.g., a rewind button to navigate to the previous track, a play/pause button to toggle (e.g., pause or resume) playback, and a skip forward button to navigate to the next track).

FIG. 5M further illustrates detecting user input 548 directed to the skip forward button displayed within the expanded indication 532c. In some embodiments, in response to user input 548, the currently playing song is updated to a next song, Song C, as illustrated in expanded indication 532d for the music session, illustrated in FIG. 5N.

FIG. 5N illustrates that, while expanded indication 532d is displayed as at least partially overlapping timer user interface 550 for the clock application, user input 552 is detected outside of the expanded indication 532d, for interacting with timer user interface 550. For example, user input 552 is a swipe user input to change an amount of time to which to set the timer in the clock application.

In some embodiments, in response to detecting user input 552 that is outside of the expanded indication 532d, the expanded indication 532d is automatically, without additional user input, minimized to status icon 532e, displayed in the status region, as shown in FIG. 5O. For example, status icon 532e for the music session includes information about the currently playing song (e.g., song C) without displaying the one or more controls that are displayed in the expanded indication 532d.

FIG. 5O illustrates user input 553 directed to the Start button displayed in timer user interface 550 to start a timer for 15 minutes and 1 second. In response to detecting user input 553, the timer starts, and timer user interface 550 is updated to display the time remaining for the timer, as illustrated in FIG. 5P.

FIG. 5P further illustrates updating battery icon 512 in response to the occurrence of an alert. For example, in response to detecting that the battery level satisfies a threshold battery level (e.g., is less than a threshold amount of battery), battery icon 512 is replaced or otherwise updated, such as by being expanded inline within the status region, to display battery alert 558, indicating “Low Battery.” In some embodiments, while battery alert 558 is displayed, the icons proximate to battery icon 512 (e.g., wireless signal icon 508 and/or Wi-Fi signal icon 510) shift within the status region to accommodate and be displayed proximate to battery alert 558. In some embodiments, because battery icon 512 is already displayed in the status region, in response to the occurrence of an alert related to battery status, information about the alert is integrated with existing battery icon 512 to form battery alert 558 (e.g., with other status icons shifted to accommodate any increased size of battery alert 558 relative to battery icon 512).

FIG. 5P illustrates detecting user input 554 corresponding to a request to navigate to home screen user interface 502, and in response to user input 554, home screen user interface 502 is displayed, as illustrated in FIG. 5Q. FIG. 5Q illustrates status icon 556a that is displayed in the status region for the ongoing timer session for the timer that was initiated, as described with reference to FIG. 5O. In some embodiments, status icon 556a for the timer session is updated to display information about the timer, such as an icon representing the timer and/or an amount of time remaining on the timer. For example, status icon 556a is updated to status icon 556b as the time remaining updates (e.g., decreasing from 14:42 to 14:41).

In some embodiments, battery alert 558 continues to be displayed while the user navigates between an application user interface (e.g., timer user interface 550) and a system user interface (e.g., home screen user interface 502), as illustrated in FIGS. 5P-5Q.

FIG. 5Q illustrates user input 560 directed to battery alert 558. In some embodiments, battery alert 558 is not associated with a particular application of the device 100. In some embodiments, in response to user input 560, battery alert 558 is expanded to include additional information and/or additional control options related to the alert. For example, as illustrated in FIG. 5R, expanded battery alert 562 is displayed that includes additional information about the alert, such as a percentage of battery level remaining, information about actions the user should take (e.g., “Plug your device in to charge the battery.”), and/or control options, such as button 564 (e.g., labeled “Low Power Mode”) corresponding to a user-selectable option to enter a low power mode in which power consumption of device 100 is reduced relative to when device 100 is not in the low power mode (e.g., and instead is in a normal operating state).

In some embodiments, in response to detecting user input 566 directed to button 564, device 100 enters the low power mode to increase battery life of device 100. In some embodiments, after detecting a user input interacting with expanded battery alert 562, the battery alert is minimized and battery icon 512 is redisplayed, optionally with a different appearance indicating that the device is now in the low power mode, for example, with a different color while the device is in the low power mode than a color of the icon while the device is not in the low power mode, as illustrated in FIG. 5S.

FIGS. 5S-5T illustrate, in response to detecting user input 568 directed to the status icon 556c for the timer session, timer user interface 550 (e.g., a user interface for the clock application) associated with the timer session is displayed. For example, for indications that represent sessions that are associated with a respective application of device 100, a user interface for the respective application is displayed in response to detecting a user input that is directed to the indication for the respective session (e.g., optionally in accordance with a determination that the user input satisfies input criteria, optionally requiring a particular type of input such as a tap input or a tap and hold input). In some embodiments, in response to a user input directed to an indication for a respective session that is not associated with a respective application, the indication expands to display additional information and/or control options without updating the user interface that is displayed in the display area outside of the status region (e.g., as described with reference to FIGS. 5J-5K for the communication session and FIGS. 5Q-5R for the battery alert). In some embodiments, for an indication for a respective session that is associated with an application, a user is enabled to expand and/or initiate display of a user interface for the application. For example, the user is enabled to access an expanded indication for the timer session (e.g., expanded indication 582, described in more detail herein with reference to FIG. 5AB) as well as access the timer user interface 550 illustrated in FIG. 5T using different types of inputs directed to status icon 556c (e.g., as determined by an input heuristic). For example, in response to detecting a first type of input directed to status icon 556c, timer user interface 550 is displayed (e.g., FIG. 5P), and in response to detecting a second type of input different from the first type of input directed to status icon 556c, an expanded indication for the timer session is displayed (e.g., FIG. 5AB).

FIG. 5T illustrates that, while the application user interface (e.g., timer user interface 550) is displayed, the indication for the respective session associated with the application ceases to be displayed (e.g., status icon 556c is no longer displayed) in the status region, while continuing to display other ongoing sessions, if any, in the status region (e.g., status icon 532e continues to be displayed while displaying timer user interface 550).

FIG. 5T illustrates detecting user input 570 corresponding to a request to navigate away from timer user interface 550 and that, in response to the user input 570, device 100 displays home screen user interface 502, as illustrated in FIG. 5U. As illustrated in FIG. 5U, the timer session is still ongoing, and thus status icon 556d for the timer session is displayed, concurrently with status icon 532e for the music session, in the status region.

FIG. 5V illustrates status icon 574 for a sharing session, for example, via a device-to-device Wi-Fi connection, Bluetooth connection, or other connection for sharing content. In some embodiments, device 100 automatically displays status icon 574, without detecting a user input, in accordance with a determination that device 100 is within a sharing range of another device and/or in response to determining that device 100 is receiving content via the sharing session. In some embodiments, status icon 574 is displayed in response to detecting a user input initiating and/or accepting a request to establish a sharing session with another device. In some embodiments, status icon 574 corresponds to a system function and is optionally not associated with a respective application of device 100. In some embodiments, status icon 574 is associated with a different type of session than the sessions associated with status icon 532e and/or status icon 556c. For example, the sharing session associated with status icon 574 is a second type of session, sometimes referred to herein as a transient, or temporary, session, while status icon 532e and/or status icon 556e are associated with sessions of a first type of session, sometimes referred to herein as a persistent session. In some embodiments, device 100 displays a respective indication at a particular location within or portion of the status region based on the type of session associated with the respective indication. For example, status icons for transient sessions are optionally displayed on the right side of the status region, while status icons for persistent sessions are optionally displayed on the left side of the status region. Other arrangements of status icons for sessions may be used.

FIG. 5W illustrates user input 572 directed to status icon 574 for the sharing session. In some embodiments, in response to user input 572, an expanded indication 576 for the sharing session is displayed. In some embodiments, regardless of the type of user input 572 directed to status icon 574, the expanded indication 576 is displayed (e.g., because status icon 574 corresponds to a system function and is not associated with a respective application of device 100). For example, the sharing session associated with status icon 574 is, in some embodiments, not associated with an application of device 100, or an application user interface, and thus the expanded indication 576 (e.g., rather than a user interface for an application) is used to interact with the sharing session. In some embodiments, the expanded indication 576 is displayed below the status region (e.g., optionally while maintaining display of status icon 574). In some embodiments, the expanded indication 576 is displayed in-line with the status region, and optionally obscures and/or overlaps with one or more of the indications and/or status icons displayed in the status region. In some embodiments, an expanded indication that is displayed in-line with or at least partially overlapping the status region moves one or more other indications and/or status icons displayed in the status region aside (e.g., expanded battery alert 562 (FIG. 5R) expands battery alert 558 (FIG. 5Q) within the status region as well as downward, and causes wireless signal icon 508 and Wi-Fi signal icon 510 to shift further to the left), and/or causes one or more of the displayed indications and/or status icons to cease to be displayed (e.g., to be hidden, at least temporarily while the expanded indication is displayed).

FIG. 5X illustrates user input 578 detected outside of the status region and/or outside of expanded indication 576. For example, user input 578 is detected in the display region displaying home screen user interface 502. In some embodiments, in response to detecting user input 578, expanded indication 576 shrinks, transitions, is animated, or otherwise ceases to be displayed, as illustrated in FIG. 5Y. In some embodiments, status icon 574 continues to be displayed in the status region while the sharing session is active.

FIG. 5Z illustrates status icon 580 representing a focus mode, such as a reduced notification mode, of device 100. For example, the reduced notification mode is selected from a plurality of focus modes, wherein each focus mode defines when certain alerts are provided to the user based on a current set of circumstances, such as a current time of day, a current location of the user, a current status of the user (e.g., driving mode, or sleeping mode), and/or whether a do not disturb mode (e.g., work mode, vacation mode, workout mode, or away mode) is enabled. In some embodiments, device 100 enters, automatically, without additional user input, the focus mode in accordance with the current set of circumstances. For example, at a certain time of day and/or location of the device 100, device 100 automatically enters a respective focus mode for the current set of circumstances, and the status icon 580 representing the focus mode is automatically, without user input, displayed in the status region to indicate that device 100 is in the respective focus mode. In some embodiments, in accordance with the current set of circumstances no longer corresponding to a focus mode, status icon 580 ceases to be displayed in the status region automatically, without user input. For example, status icon 580 is no longer displayed in the status region illustrated in FIG. 5AA, in response to the current set of circumstances no longer corresponding to the respective focus mode.

FIG. 5AA illustrates device 100 changed to a second orientation, for example, a portrait orientation, distinct from the first orientation (e.g., a landscape orientation) illustrated in FIGS. 5A-5Z. In some embodiments, device 100 changes orientation in response to detecting a physical input to device 100, for example, physically rotating device 100, as detected by one or more accelerometers 168. In some embodiments, the status region is updated to be displayed at a different location on the display while the device 100 is in the second orientation, as compared to the location on the display in the first orientation, such that the status region appears at a top portion of the display within its current view determined by the current orientation of device 100. In some embodiments, the status region is reoriented on the display so as to maintain a respective spatial relationship to device 100 in the current orientation (e.g., the status region is displayed at the top portion of the display both while device 100 is in portrait orientation and while device 100 is in landscape orientation)

In some embodiments, status icons for ongoing sessions continue to be displayed in the status region in the second orientation in FIG. 5AA. For example, status icon 532f for the music session and indication 556j for the timer session continue to be displayed at corresponding respective positions within the reoriented status region. As such, the status icons continue to be displayed after device 100 has switched between the first orientation and the second orientation (e.g., and vice-versa).

FIG. 5AB illustrates expanded indication 582 for the timer session. In some embodiments, expanded indication 582 is automatically, without user input, displayed in accordance with a determination that a session event has occurred. For example, upon the timer reaching 0:00, the timer is to provide an alert that the timer has reached its end. In some embodiments, in response to detecting that the timer application is to provide an alert, expanded indication 582 is displayed. In some embodiments, expanded indication 582 includes one or more controls for interacting with the alert, including a user-selectable control (e.g., labeled “Stop”) to stop the timer alert (e.g., to stop any audio, haptic, visual, and/or other feedback provided for the timer alert), and/or a user-selectable control (e.g., labeled “Repeat”) to repeat the timer (e.g., to restart the timer, for example, reset the timer to 15 minutes and 1 second).

In some embodiments, expanded indication 582 is displayed outside of the status region, and overlapping with the home screen user interface 502 that is displayed. For example, expanded indication 582 overlaps and/or occludes one or more application icons displayed in the home screen user interface 502. In some embodiments, expanded indication 582 is displayed as expanding from (e.g., and/or including at least a portion of) the status region. For example, expanded indication 582 is displayed as overlapping time indication 504 and/or date indication 506 and/or status icon 532f for the music session. As such, the status region is, in some embodiments, updated to display the expanded indication 582, optionally with expanded indication 582 extending outside of the status region.

FIG. 5AB further illustrates user input 584 directed to the user-selectable control labeled “Stop” to stop the timer alert. In some embodiments, in response to user input 584, the expanded indication 582 ceases to be displayed, as illustrated in FIG. 5AC (e.g., and other audio, haptic, visual, and/or other feedback provided for the timer alert ceases to be provided).

In some embodiments, charging status icon 586 is displayed in response to detecting that an event has occurred. For example, in response to detecting that device 100 is connected to a power source, for example, in response to detecting that device 100 is connected for wired and/or wireless charging, charging status icon 586 is displayed. In some embodiments, the charging status icon 586 replaces display of the battery icon 512. For example, because the detected event (e.g., connection to a power source) is related to the battery and/or battery icon 512, battery icon 512 is replaced, or otherwise updated to display, charging status icon 586. In some embodiments, the status indicators proximate to the battery icon 512 are shifted (e.g., to the right and/or left) in order to avoid overlapping with the charging status icon 586, as illustrated in FIG. 5AB.

In some embodiments, in response to detecting user input 588 directed to charging status icon 586, charging status icon 586 expands or otherwise updates to provide additional information about a charging session of device 100. For example, in FIG. 5AC, platter 590 is displayed, where platter 590 includes additional information and/or controls about the charging session. Platter 590 in FIG. 5AC, displayed separate from and below charging status icon 586 in the status region, illustrates an alternative way of providing additional information and/or control options in an expanded alert to that of expanded battery alert 562 in FIG. 5R, (e.g., which is displayed at least partially in the status region and integrated with battery alert 558).

In some embodiments, in response to detecting user input 592 that is not directed to the status region and/or directed to platter 590, the charging status icon 586 and/or platter 590 (e.g., indicating an active and/or unread alert) cease to be displayed, and battery icon 512b is redisplayed in the status region, as illustrated in FIG. 5AD. In some embodiments, battery icon 512b is displayed with one or more visual properties that indicate that charging is ongoing (e.g., a charging symbol as shown in FIG. 5AD), but is not displayed as a status icon with an associated unread alert or active session (e.g., because the alert has already been acknowledged, such as by being viewed and then dismissed in FIGS. 5AB-5AC).

In response to detecting user input 594 directed to the status region, as illustrated in FIG. 5AD, in some embodiments, the status region does not update (e.g., to show an expanded indication or application user interface). For example, because user input 594 is directed to battery icon 512b which no longer indicates an active and/or unread alert, rather than being directed to an indication corresponding to an ongoing session or active alert, device 100 does not perform an operation (e.g., does not display an expanded indication and/or display an application user interface). In some embodiments, in response to detecting user input 594, device 100 optionally provides haptic and/or audio feedback (e.g., indicative of device 100 not displaying an expanded indication or application user interface, and different from haptic and/or audio feedback that is optionally provided in conjunction with displaying an expanded indication or application user interface), without updating display of the status region.

FIG. 5AE illustrates user input 596 corresponding to a downward swipe input that causes device 100 to display, as shown in FIG. 5AF, control user interface 597 (e.g., or control interface 498 as described with reference to FIG. 4C). In some embodiments, in response to user input 598 directed to a control for initiating screen recording of device 100, a screen recording session is initiated. In some embodiments, in response to detecting user input 5002 corresponding to a request to navigate away from control user interface 597, home screen user interface 502 is redisplayed.

In some embodiments, while the screen recording session is ongoing, status icon 5004 for the screen recording session is displayed in the status region, as illustrated in FIG. 5AG. In some embodiments, the screen recording session is a transient session, and is optionally displayed on the right side of the status region, and/or is displayed adjacent to and without overlapping wireless signal icon 508, Wi-Fi signal icon 510 and/or battery icon 512 (e.g., optionally without shifting wireless signal icon 508, Wi-Fi signal icon 510 and/or battery icon 512 within the status region). In some embodiments, the screen recording session is a persistent session, and status icon 5004 for the screen recording session is optionally displayed on the left side of the status region, and/or is displayed adjacent to and without overlapping time indication 504, date indication 506, and/or other status icons displayed on the left side of the status region for persistent sessions.

In some embodiments, system status icons (optionally whether persistent or temporary) are displayed on the right side of the status region, whereas application session status icons (optionally whether persistent or transient) are displayed on the left side of the status region. For example, even if the screen recording session is a persistent session, status icon 5004 for the screen recording session is displayed on the right side of the status region due to being associated with a system function, whereas status icon for application sessions (e.g., status icon 518 for the communication session of a telephone application, indication 522 for the communication signal for a payment application, status icon 532 for the music session of a music application, and/or status icon 556 for the timer session of a clock application) are displayed on the left side of the status region due to being associated with an application (e.g., even if the associated session is temporary, as is optionally the case for the communication signal for the payment application, represented by indication 522).

In some embodiments, in response to user input 5006 directed to the status icon 5004 for the screen recording session, expanded indication 5008 for the screen recording session is displayed (e.g., at least partially within or entirely outside of the status region as described herein with respect to other expanded indications such as expanded indication 518j for the communication session (FIG. 5K), expanded battery alert 562 (FIG. 5R), or expanded indication 576 for the sharing session (FIG. 5X)). In some embodiments, expanded indication 5008 optionally includes one or more user-selectable controls for interacting with the screen recording session. For example, in FIG. 5AH, in response to user input 5010 selecting the stop control in expanded indication 5008, the screen recording session is ended, and the status icon 5004 is no longer displayed in the status region.

FIGS. 6A-6D are flow diagrams illustrating method 6000 of updating status information within a region of a display area in accordance with some embodiments. Method 6000 is performed at a computer system (e.g., device 300, FIG. 3, or portable multifunction device 100, FIG. 1A) with a display generation component (e.g., touch screen 112, FIG. 1A, or display 340, FIG. 3). In some embodiments, the display generation component is a touch-screen display and optionally includes a touch-sensitive surface that is on or integrated with the display. In some embodiments, the display generation component is separate from the touch-sensitive surface. Some operations in method 6000 are, optionally, combined and/or the order of some operations is, optionally, changed.

As described below, method 6000 provides a method for updating status information within a region of a display area in accordance with some embodiments. As described herein, displaying information about an active session of software, such as an application, in a status region (e.g., during interaction with a user interface of another application and/or system user interface displayed in display area outside of the status region) enables the user to view different types of status information for the computer system in a consistent region of the display while making more efficient use of the display area, thereby reducing an amount of time needed to perform a particular operation on the device.

The computer system displays (6002), via the display generation component, a status bar (e.g., also referred to herein as a status region) that includes one or more status icons, wherein a first status icon of the one or more status icons indicates a state of a first function of the computer system. In some embodiments, the status bar includes a plurality of status icons (e.g., concurrently displayed status icons), including the first status icon that is associated with and/or indicates the state of the first function of the computer system, and a second status icon that is associated with and/or indicates a state of a different, second function of the computer system. In some embodiments, each of a plurality of different status icons in the plurality of status icons in the status bar is associated with and/or indicates a state of a different corresponding function of the computer system.

The computer system displays (6004) outside of the status bar, via the display generation component, a user interface of respective software executing on the computer system (e.g., an operating system user interface or application user interface).

The computer system detects (6006) an occurrence of an alert. For example, as described with reference to FIG. 5A, an indication 514 corresponding to an incoming call is displayed.

The computer system, in response to detecting the occurrence of the alert, while continuing to display the user interface of the respective software outside of the status bar, displays (6008) in the status bar an indication of the alert, including: in accordance with a determination that the alert corresponds to the first status icon of the one or more status icons in the status bar (e.g., the alert pertains to the first function indicated by the first status icon), the computer system updates (6010) the first status icon to include an indication of an occurrence of the alert (e.g., as described with reference to FIG. 5P, battery icon 512 is updated in response to detecting a change in battery status, which corresponds to already-displayed battery icon 512) (e.g., including information about the alert or a visual change in the status icon indicating that an alert corresponding to the status icon has occurred) (e.g., without updating other status icons in the plurality of status icons). In some embodiments, if the alert corresponds to a different, second icon of the one or more status icons (e.g., the alert pertains to a second function indicated by the second status icon), the second status icon is updated to include information about the alert instead. In some embodiments, if the alert pertains to a respective function that is not indicated by any of the one or more status icons, a status icon (e.g., status icon 518a, status icon 532a, status icon 532e, status icon 574, and/or another status icon) indicating the respective function is added to the status bar. In some embodiments, the first status icon with information about the alert is updated over time (e.g., the information in the first status icon changes) as a state of the respective function changes. In some embodiments, displaying the indication of the alert includes displaying a respective alert icon indicative of the alert. In some embodiments, the respective alert icon is an update to a status icon already displayed in the status bar (e.g., the first status icon, second status icon, or other status icon in the status bar) or is added to the status bar. For example, as described with reference to FIGS. 5B-5J, status icon 518 is displayed for the ongoing communication session.

The computer system detects (6012) an input (e.g., user input 542, user input 560 and/or another user input) directed to the status bar. In response to detecting the input directed to the status bar (6014): in accordance with a determination that the input is directed to the first status icon in the status bar, the computer system performs (6016) a first operation (e.g., associated with the first status icon). For example, as described with reference to user input 542 in FIG. 5J, in response to detecting the user input 542, an expanded indication 518j is displayed, as illustrated in FIG. 5K.

In response to detecting the input directed to the status bar (6014): in accordance with a determination that the input is directed to a second status icon in the status bar, wherein the second status icon is different from the first status icon, the computer system forgoes performing (6018) the first operation (e.g., and optionally, performs a second operation (e.g., associated with the second status icon) that is different from the first operation). For example, as described with reference to FIG. 5Q, in response to the user input 560 that is directed to battery alert 558, the expanded indication 518j is not displayed, and, optionally, a different operation is performed, such as display of expanded battery alert 562 for the icon selected by the user input 560, as illustrated in FIG. 5R.

Automatically displaying a status region to include a status icon that includes information about an alert, including updating a status icon in the status region to include an indication of an alert when the alert is related to the status icon, and allowing user to interact with the status icon to view additional information and/or view an application associated with the status icon, visually emphasizes information that is relevant to a status icon and/or more prominently displays information about an alert and allows the user to easily access additional information about an alert via the status region, thereby providing feedback about a state of the device and reducing a number of inputs required to navigate to an application user interface, or other information, related to the alert.

In some embodiments, in response to detecting the occurrence of the alert, while continuing to display the user interface of the respective software outside of the status bar, displaying in the status bar an indication of the alert includes (6020): in accordance with a determination that the alert corresponds to the second status icon of the one or more status icons in the status bar (e.g., the alert pertains to the first function indicated by the first status icon), updating the second status icon to include an indication of an occurrence of the alert (e.g., including information about the alert or a visual change in the status icon indicating that an alert corresponding to the status icon has occurred) (e.g., without updating the first status icon). In some embodiments, the alert optionally does not correspond to a status icon, and is displayed as an alert icon in the status bar (e.g., the alert corresponds to an application, a system function, or other alert that is not integrated and/or related to a status icon currently displayed in the status bar). In some embodiments, the second status icon is displayed concurrently with other status icons (e.g., that optionally correspond to one or more other alerts). For example, as described with reference to FIG. 5P, in accordance with the indication of the alert being associated with the battery icon 512, the battery alert 558 is displayed as an updated version of the battery icon 512. In another example, if a sharing status icon (e.g., with one or more graphical elements analogous to status icon 574) is displayed in the status region while a sharing session is not active (e.g., a sharing session request has not been sent, received, or accepted), in response to a sharing session being requested or initiated, the inactive sharing status icon is updated to status icon 574 (e.g., highlighted and/or expanded). Automatically displaying, in the status region, an indication of an alert that is related to a respective status icon in the status region, by updating the respective status icon associated with the alert, and allowing a user to interact with the status icon to view additional information and/or view an application associated with the status icon, visually emphasizes information that relevant to a respective status icon and/or more prominently displays information about an alert and allows the user to easily access additional information about an alert via the status region, thereby providing feedback about a state of the device.

In some embodiments, in response to detecting the occurrence of the alert, displaying in the status bar the indication of the alert includes (6022): in accordance with a determination that the alert does not correspond to the one or more status icons in the status bar (e.g., the alert does not relate to a function indicated by any of the one or more already-displayed status icons), displaying, in the status bar, an alert icon (e.g., the second status icon) that is different from the one or more status icons and that indicates a state of a respective function of the computer system (e.g., and the respective function is not indicated by any of the one or more already-displayed status icons), wherein the alert icon includes information about the alert and is updated over time (e.g., the information in the alert icon changes) as a state of the respective function changes. For example, as described with reference to FIGS. 5A-5B, the communication session is not associated with one of the wireless signal icon 508, the Wi-Fi signal icon 510 and/or the battery icon 512, and status icon 518a is displayed separate from the wireless signal icon 508, the Wi-Fi signal icon 510 and/or the battery icon 512. In some embodiments, as described with reference to FIG. 5V, indications for different alerts are optionally displayed at different positions within the status bar. For example, status icons for transient sessions are optionally displayed on the right side of the status region, while status icons for persistent sessions are optionally displayed on the left side of the status region. Displaying, in the status region, a different status icon that includes information associated with the alert, rather than updating an already-displayed status icon, when the alert is not related to an already-displayed status icon that is already displayed in the status region, including updating the information over time based on a current state of the device, reduces the number of inputs and the amount of display area needed for viewing feedback about a state of the device.

In some embodiments, updating the first status icon to include the indication of the occurrence of the alert includes (6024) updating the first status icon while maintaining a position of the first status icon relative to other status icons in the status bar. In some embodiments, the status bar extends in a first direction (e.g., vertically, horizontally, or other direction across a display area) and/or in a second direction (e.g., a second dimension, such as a height or thickness, of the status bar) across the display area. In some embodiments, the first status icon is expanded within the status bar, optionally without changing a size of the status bar. For example, the battery alert 558 is an expanded version of the battery icon 512 to which the alert is related, where the battery alert 558 expands inline within the status region, proximate to the status icons that are displayed proximate to the battery icon 512 (e.g., wireless signal icon 508 and/or Wi-Fi signal icon 510 continue to be displayed proximate to the battery alert 558). Updating, in the status region, an already-displayed status icon with information about an alert, when the alert is related to the already-displayed status icon that is already displayed in the status region, including maintaining a position of the already-displayed status icon while displaying the information about the alert, reduces the cognitive burden on the user by maintaining the respective positions of icons in the status region and makes more efficient use of the display area.

In some embodiments, updating the first status icon to include the indication of the occurrence of the alert includes (6026) updating the first status icon while changing respective positions of one or more other status icons within the status bar (e.g., shifting one or more of the other status icons to the left and/or right such that the other status icons remain visible while the first status icon is displayed in the status bar). In some embodiments, the one or more other status icons in the status bar are shifted in accordance with a determination that the first status icon is displayed at a position in the status bar that overlaps with the one or more status icons. For example, the battery alert 558 is an expanded version of the battery icon 512 to which the alert is related, and the battery alert 558 causes the other status icons, including Wi-Fi signal icon 510 and wireless signal icon 508 to shift to the left while the battery alert 558 is expanded (e.g., as to not overlap with Wi-Fi signal icon 510 and/or wireless signal icon 508). Updating the status region, to include a status icon that includes information about an alert, and automatically changing positions of one or more already-displayed status icon in the status region, causes the device to automatically allocate more display area to and improve the visual emphasis on the additional information for the particular aspect being featured as well as automatically optimizes the placement of the status information to avoid truncation or distortion of the status icon.

In some embodiments, performing the first operation in accordance with a determination that the input (e.g., a tap input, a tap and hold input, or another type of selection input) is directed to the first status icon in the status bar includes displaying (6028), outside of the status bar, a user interface for a respective application that is associated with the first status icon. In some embodiments, the first status icon to which the input is directed has been updated to include the indication of the occurrence of the alert. In some embodiments, the user interface for the respective application that is associated with the respective alert icon replaces display of the user interface of respective software executing on the computer system that is displayed outside of the status bar. For example, as described with reference to FIG. 5S, in response to detecting the user input 568 directed to the status icon 556c for the ongoing timer session, the device 100 updates to display the user interface 550 for the timer application that is associated with the status icon 556c. Displaying a user interface for an application that is associated with the respective status icon, in response to a user input that is directed to the respective status icon, in the display area that is outside of the status region, reduces the number of inputs needed to access additional feedback about a state of the device and enables the user to more efficiently access a user interface for the application associated with the status icon.

In some embodiments, the computer system, in response to detecting the input directed to the status bar: in accordance with a determination that the input is directed to the indication of the alert, updates (6030) the indication of the alert to display information about the alert. In some embodiments, updating the indication of the alert includes expanding and/or increasing a size (e.g., vertically and/or horizontally) of a respective alert icon (e.g., an existing status icon updated to include the indication of the occurrence of an alert or an added alert icon indicating the occurrence of the alert) to display additional information about the alert. For example, as described with reference to FIGS. 5Q-5R, in response to detecting the user input 560 directed to the low battery alert shown in the battery alert 558, the battery alert 558 is updated (e.g., expanded or otherwise increases in size) to display the expanded battery alert 562, including displaying additional information related to the alert, optionally including one or more selectable controls for interacting with the alert. Expanding the status icon to include additional status information in response to a user input, particularly a user input that is directed to the status region, reduces the number of inputs needed to access additional feedback about a state of the device.

In some embodiments, in response to detecting the input directed to the status bar (6032): in accordance with a determination that the input is a first type of input directed to a respective alert icon in the status bar (e.g., the indication of the alert, such as an update to an existing status icon or added alert icon, or other status bar icon), the computer system displays, outside of the status bar, a user interface for a respective application that is associated with the respective alert icon (e.g., including replacing display of the user interface of respective software executing on the computer system that is displayed outside of the status bar with the user interface for the respective application). In some embodiments, in response to detecting the input directed to the status bar, in accordance with a determination that the input is a second type of input directed to the respective alert icon, wherein the second type of input is different from the first type of input, the computer system updates the respective alert icon (e.g., increases a size, expands horizontally and/or vertically, optionally without displaying the user interface for the respective application) to display information about the alert. For example, as described with reference to FIGS. 5S-5T, in some embodiments, based on the type of user input that is detected, an expanded version of the status icon and/or a user interface for an application corresponding to the status icon is displayed. Automatically either expanding the status icon and/or the status region to include additional status information in response to detecting a first type of user input that is directed to the status icon, or displaying a user interface for an application that is associated with the respective status icon in the display area that is outside of the status region in response to detecting a second type of user input, provides the user with additional control options and reduces the number of inputs needed to access additional feedback about a state of the device.

In some embodiments, the first type of input comprises (6034) an input that is detected for less than a threshold amount of time and the second type of input is an input that is detected for at least the threshold amount of time (e.g., the first type of input is a tap input, and the second type of input is a press and hold input). In some embodiments, the first type of input and/or the second type of input is a stationary input that optionally does not include dragging, swiping, or other detected movement of the input. For example, as described with reference to FIGS. 5S-5T, in response to detecting a first type of input directed to status icon 556c, timer user interface 550 is displayed (e.g., FIG. 5P), and in response to detecting a second type of input different from the first type of input directed to status icon 556c, an expanded indication for the timer session is displayed (e.g., FIG. 5AB). Automatically either expanding the status icon and/or the status region to include additional status information in response to detecting a first type of user input, particularly a tap input, that is directed to the status icon, or displaying a user interface for an application that is associated with the respective status icon in the display area that is outside of the status region in response to detecting a second type of user input, particularly a press and hold input, provides the user with additional control options and reduces the number of inputs needed to access additional feedback about a state of the device.

In some embodiments, updating the respective alert icon to display information about the alert in accordance with a determination that the input is the second type of input includes displaying (6036), in the respective alert icon (e.g., in the updated and/or expanded first status icon), one or more controls for interacting with the alert. For example, as described with reference to FIG. 5AB, the expanded indication 582 for the timer session includes one or more selectable controls, such as stop or repeat. Increasing the size of the alert icon and/or status icon while displaying new information in the status region, including displaying controls related to the alert icon and/or status icon, visually emphasizes information that is more relevant and/or of greater interest to the user, thereby providing feedback about a state of the device and dynamically provides additional control options for the user.

In some embodiments, in response to detecting the input directed to the status bar (6038): in accordance with a determination that the input is directed to a respective alert icon that is associated with a respective application, the computer system replaces display, outside of the status bar, of the user interface of respective software executing on the computer system with a user interface for the respective application associated with the respective alert icon (e.g., and optionally ceasing display of the respective alert icon while displaying the user interface for the application associated with the respective icon). In some embodiments, in accordance with a determination that the input is directed to the respective alert icon and the respective alert icon is not associated with a respective application (e.g., the first status icon represents a system alert (e.g., low battery, software update, wireless file transfer, or other system alert)), the computer system expands the respective alert icon to display additional information about the alert (e.g., while maintaining the user interface of respective software executing on the computer system displayed outside of the status bar). In some embodiments, in response to detecting a user input directed to the status bar that is not directed to a respective alert icon, the computer system forgoes performing an operation in response such as replacing display of the user interface outside of the status bar or expanding a respective alert icon to display additional information (e.g., if the user input is directed to the status bar that does not include a respective alert indication and/or the input is not directed to a respective alert indication, the display of the status bar and the user interface of respective software displayed outside of the status bar are maintained). For example, as described with reference to FIGS. 5W-5X, regardless of whether the user input 572 is a first type of user input or a second type of user input, the expanded version of the expanded indication 576 is displayed because there is not an application user interface that is associated with the status icon 574. Automatically displaying a user interface for an application that is associated with the respective status icon in the display area that is outside of the status region, or expanding the status icon to include additional status information if no application is associated with the status icon, in response to a user input directed to the status icon, causes the device to automatically allocate more display area to and improve the visual emphasis on the application user interface when it is available for the particular aspect being featured, thereby providing improved feedback about a state of the device.

In some embodiments, detecting the occurrence of the alert comprises (6040) detecting occurrence of a first alert. In some embodiments, displaying in the status bar the indication of the alert includes displaying a respective alert icon indicative of the first alert. In some embodiments, the computer system concurrently displays in the status bar, the respective alert icon indicative of the first alert and one or more additional alert icons indicative of one or more alerts different from the first alert. For example, the method includes receiving a second alert, different from the first alert, and concurrently displaying the respective alert icon indicative of the first alert and a second respective alert icon indicative of the second alert. In some embodiments, two or more indications are concurrently displayed, each indication corresponding to a different application and/or system alert. In some embodiments, the one or more alerts are displayed proximate to each other. In some embodiments, the one or more alerts are displayed on different portions of the status bar. For example, a status icon that is associated with a first application is displayed on the left side of the status bar and a status icon that is associated with a second application is displayed on the right side of the status bar. In some embodiments, the displayed position of the status icon is based at least in part on the type of icon (e.g., whether the icon is a temporary icon and/or a persistent icon). For example, a temporary icon is displayed on the right side of the status bar while a persistent icon is displayed on the left side of the status bar. In some embodiments, a temporary icon automatically disappears, without additional user input, within a threshold amount of time; a persistent icon is associated with a status of an application and updates as the status of the application updates until the status reaches a completed status and/or a user input ends the session associated with the persistent icon. For example, as described with reference to FIG. 5F, a plurality of status icons are displayed in the status bar, each status icon corresponding to a respective ongoing session, including the status icon 532a for the music session, the status icon 518e for the communication session and/or the status icon 524 for the NFC signal (e.g., a payment session). Concurrently displaying different types of alert icons in the status region further reduces the number of inputs and the amount of display area needed for viewing feedback about a state of the device by providing feedback about the states of multiple aspects of the device at the same time.

In some embodiments, concurrently displaying in the status bar, the respective alert icon indicative of the first alert and the one or more additional alert icons indicative of one or more alerts different from the first alert includes (6042): displaying a second alert icon indicative of a second alert that is different from the one or more status icons (e.g., the second alert is not related to a status icon) and that indicates a state of a second function of the computer system (e.g., a function of a respective application); and displaying a third alert icon indicative of a third alert that corresponds to a third status icon of the one or more status icons, including updating the third status icon to include an indication of an occurrence of the third alert. For example, as described with reference to FIG. 5P, while the status icon 532e for the music session is displayed (e.g., that is not associated with the status icons 508, 510 and/or 512), the battery alert 558 is concurrently displayed as integrated with the battery icon 512. Where the status region is used to display status information for multiple aspects of the computer system (e.g., active sessions of software applications and/or system software), integrating a respective alert icon with an already-displayed status icon that is related to the respective alert icon to show additional information for a particular aspect of the computer system (e.g., a particular status icon), and displaying a separate alert icon for an alert that is not associated with an already-displayed status icon causes the device to reduce the amount of display area in the status region needed for viewing feedback about a state of the device and makes more efficient use of the display area.

In some embodiments, detecting the occurrence of the alert includes (6044) detecting that one or more battery criteria have been met, and the indication of the alert corresponds to a battery alert icon (e.g., wherein the first status icon is a battery icon). For example, the one or more battery criteria are met in accordance with a determination that a battery level satisfies a threshold battery level (e.g., a low battery alert occurs in accordance with a determination that a battery level is less than the threshold battery level), and/or the one or more battery criteria are met in accordance with a determination that the battery is in a charging state (e.g., in response to detecting the device is plugged in and/or wirelessly charging). For example, as described with reference to FIG. 5P, a low battery alert causes the device 100 to display the battery alert 558. Displaying, in the status region, battery status information reduces the number of inputs and the amount of display area needed for viewing feedback about a state of the device.

In some embodiments, detecting the occurrence of the alert includes (6046) detecting that a screen recording is initiated. For example, as described with reference to FIGS. 5AF-5AH, a status icon 5004 is displayed corresponding to an ongoing screen recording session. In some embodiments, screen recording is initiated in response to detecting a user input selecting a screen recording option that causes the computer system to record and/or store a representation of the user interface(s) (e.g., optionally including the status bar of the computer system) displayed via the display generation component. Displaying, in the status region, screen recording information reduces the number of inputs and the amount of display area needed for viewing feedback about a state of the device.

In some embodiments, detecting the occurrence of the alert includes (6048) detecting that the computer system has entered a restricted mode. For example, as described with reference to FIG. 5Z, in some embodiments, a status icon 580 is displayed representing a restricted notifications mode (also called a reduced notification mode). In some embodiments, the restricted mode corresponds to one or more focus modes, such as a do not disturb mode, a work mode, a driving mode, or another mode. For example, the reduced notification mode is selected from a plurality of focus modes, wherein each focus mode defines when certain alerts are provided to the user based on a current set of circumstances, such as a current time of day, a current location of the user, a current status of the user (e.g., driving mode, sleeping mode), and/or whether a do not disturb mode is enabled. In some embodiments, different sets and/or types of alerts are selected as being allowed and/or suppressed in a respective focus mode (e.g., a notification of a first type of notification is suppressed in a first focus mode, such as do not disturb, and a notification of the first type of notification is not suppressed in a second focus mode, such as work mode). In some embodiments, the alert occurs in accordance with a change in mode, for example upon initiating and/or ending a focus mode. In some embodiments, the respective alert icon indicative of the device entering the restricted mode is maintained in the status bar while the device is in the restricted mode and the respective alert icon ceases to be displayed in accordance with the device no longer being in the restricted mode. Displaying, in the status region, an indication of a restricted mode and/or focus mode reduces the number of inputs and the amount of display area needed for viewing feedback about a state of the device.

In some embodiments, detecting the occurrence of the alert includes (6050) detecting that media sharing is active. In some embodiments, detecting that media sharing is active includes detecting data transfer between the computer system and one or more computer systems distinct from the computer system. In some embodiments, the data transfer is performed over device-to-device Wi-Fi, NFC, Bluetooth, and/or another communications protocol. For example, as described with reference to FIGS. 5V-5Z, a status icon 574 is displayed for an ongoing sharing session. Displaying, in the status region, information associated with wireless media sharing, such as a current sharing progress and/or type of wireless connection being used, reduces the number of inputs and the amount of display area needed for viewing feedback about a state of the device.

In some embodiments, while displaying the indication of the alert (6052), the computer system: while the display generation component is in a first orientation, displays the status bar, including the one or more status icons and the indication of the alert, at a first position of the display generation component in the first orientation. In some embodiments, in response to detecting an event (e.g., rotation of the device or other event) that causes the display generation component to change from the first orientation to a second orientation (e.g., landscape to portrait or vice versa), the computer system displays the status bar, including the one or more status icons and the indication of the alert, at the first position of the display generation component in the second orientation. For example, the status bar continues to be displayed at a top position of the display generation component regardless of the current orientation, or other characteristic position relative to the display generation component in its current orientation, such as along an edge, in a corner. For example, as described with reference to FIGS. 5Z-5AA, the status bar, and the status icons for the ongoing sessions, continue to be displayed while the device 100 is in a first orientation (e.g., a landscape orientation) and a second orientation (e.g., a portrait orientation). Maintaining the status icons within the status region while displaying a user interface for system and/or software applications in the display area, even after switching an orientation of the device, and updating the position of the status region in accordance with the current orientation of the device, causes the device to reduce unintended interaction with the status region (e.g., that might occur if the status region were not updated to a same relative position in the new device orientation) while the user is in the process of changing orientations of the device.

In some embodiments, displaying, outside of the status bar, the user interface of respective software executing on the computer system includes (6054) displaying a system user interface while concurrently displaying the status bar. In some embodiments, the system user interface corresponds to a wake screen user interface, a home screen user interface, a control user interface, a widgets user interface, a multitasking user interface, and/or another type of system user interface. In some embodiments, the status bar is optionally not maintained while displaying one or more of the system user interfaces. For example, some of the system user interfaces are concurrently displayed with the status bar, while other system user interfaces are displayed and the status bar ceases to be displayed. In some embodiments, the status bar continues to be displayed while the display area is updated (e.g., from displaying a first system user interface to displaying a second system user interface and/or to displaying an application user interface, and vice-versa). For example, the display area optionally displays a transition (e.g., an animated transition or other visual effect) while updating the user interface that is displayed in the display area outside of the status bar, and the status bar (e.g., and status icon(s)) is maintained before, during and/or after the transition. For example, as described with reference to FIGS. 5A-5D, the status bar, and status icon 518 and/or status icon 524, are concurrently displayed with the home screen user interface 502 and/or another system user interface. Maintaining the appearance of the status region, while also displaying a system user interface, causes the device to maintain visibility of information provided in the status region, such as status icons and/or alert icons, during updates to the display area outside of the status region, thereby reducing the number of inputs and the amount of display area needed for viewing feedback about a state of the device.

In some embodiments, displaying, outside of the status bar, the user interface of respective software executing on the computer system includes (6056) displaying an application user interface for an application of the computer system, while concurrently displaying the status bar. In some embodiments, the application user interface for the application of the computer system is a third-party software application. In some embodiments, the user interface of the respective software is displayed in the full display area that is outside of the status bar, and while the status icon is expanded, the expanded status icon overlaps at least part of the user interface of the respective software (e.g., expands past the status bar into a portion of the display area that is outside of the non-expanded status bar). In some embodiments, the status bar continues to be displayed while the display area is updated (e.g., from displaying a first application user interface of first respective software to displaying a second application user interface of second respective software and/or to displaying a system user interface, and vice-versa). For example, the display area optionally displays a transition (e.g., an animated transition or other visual effect) while updating the user interface that is displayed in the display area outside of the status bar, and the status bar (e.g., and status icon(s)) is maintained before, during and/or after the transition. For example, as described with reference to FIG. 5E, the status bar, and status icon 518 and/or status icon 524, are concurrently displayed with an application user interface 526 for the music application (e.g., and/or a user interface for another application, such as the timer user interface 550 illustrated in FIGS. 5M-5P). Maintaining the appearance of the status region while also displaying a user interface for a respective software application, causes the device to maintain visibility of information provided in the status region, such as status icons and/or alert icons, during updates to the display area outside of the status region, thereby reducing the number of inputs and the amount of display area needed for viewing feedback about a state of the device.

It should be understood that the particular order in which the operations in FIGS. 6A-6D have been described is merely an example and is not intended to indicate that the described order is the only order in which the operations could be performed. One of ordinary skill in the art would recognize various ways to reorder the operations described herein.

The operations described above with reference to FIGS. 6A-6D are, optionally, implemented by components depicted in FIGS. 1A-1B. For example, displaying operation 6002, detecting operation 6006, and performing operation 6016 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface (or whether rotation of the device) corresponds to a predefined event or sub-event, such as selection of an object on a user interface, or rotation of the device from one orientation to another. When a respective predefined event or sub-event is detected, event recognizer 180 activates an event handler 190 associated with the detection of the event or sub-event. Event handler 190 optionally uses or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method, comprising:
at a computer system that is in communication with a display generation component:
displaying, via the display generation component, a status bar that includes one or more status icons, wherein a first status icon of the one or more status icons indicates a state of a first function of the computer system;
displaying outside of the status bar, via the display generation component, a user interface of respective software executing on the computer system;
detecting an occurrence of an alert; and
in response to detecting the occurrence of the alert, while continuing to display the user interface of the respective software outside of the status bar, displaying in the status bar an indication of the alert, including:
in accordance with a determination that the alert corresponds to the first status icon of the one or more status icons in the status bar, updating the first status icon to include an indication of an occurrence of the alert;
detecting an input directed to the status bar; and
in response to detecting the input directed to the status bar:
in accordance with a determination that the input is directed to the first status icon in the status bar, performing a first operation; and
in accordance with a determination that the input is directed to a second status icon in the status bar, wherein the second status icon is different from the first status icon, forgoing performing the first operation.

2. The method of claim 1, wherein, in response to detecting the occurrence of the alert, while continuing to display the user interface of the respective software outside of the status bar, displaying in the status bar an indication of the alert includes:
in accordance with a determination that the alert corresponds to the second status icon of the one or more status icons in the status bar, updating the second status icon to include an indication of an occurrence of the alert.

3. The method of claim 1, wherein, in response to detecting the occurrence of the alert, displaying in the status bar the indication of the alert includes:
in accordance with a determination that the alert does not correspond to the one or more status icons in the status bar, displaying, in the status bar, an alert icon that is different from the one or more status icons and that indicates a state of a respective function of the computer system, wherein the alert icon includes information about the alert and is updated over time as a state of the respective function changes.

4. The method of claim 1, wherein:
updating the first status icon to include the indication of the occurrence of the alert includes updating the first status icon while maintaining a position of the first status icon relative to other status icons in the status bar.

5. The method of claim 1, wherein updating the first status icon to include the indication of the occurrence of the alert includes updating the first status icon while changing respective positions of one or more other status icons within the status bar.

6. The method of claim 1, wherein performing the first operation in accordance with a determination that the input is directed to the first status icon in the status bar includes displaying, outside of the status bar, a user interface for a respective application that is associated with the first status icon.

7. The method of claim 1, including:
in response to detecting the input directed to the status bar:
in accordance with a determination that the input is directed to the indication of the alert, updating the indication of the alert to display information about the alert.

8. The method of claim 1, including, in response to detecting the input directed to the status bar:
in accordance with a determination that the input is a first type of input directed to a respective alert icon in the status bar, displaying, outside of the status bar, a user interface for a respective application that is associated with the respective alert icon; and
in accordance with a determination that the input is a second type of input directed to the respective alert icon, wherein the second type of input is different from the first type of input, updating the respective alert icon to display information about the alert.

9. The method of claim 8, wherein the first type of input comprises an input that is detected for less than a threshold amount of time and the second type of input is an input that is detected for at least the threshold amount of time.

10. The method of claim 8, wherein updating the respective alert icon to display information about the alert in accordance with a determination that the input is the second type of input includes displaying, in the respective alert icon, one or more controls for interacting with the alert.

11. The method of claim 1, including, in response to detecting the input directed to the status bar:
in accordance with a determination that the input is directed to a respective alert icon that is associated with a respective application, replacing display, outside of the status bar, of the user interface of respective software executing on the computer system with a user interface for the respective application associated with the respective alert icon; and
in accordance with a determination that the input is directed to the respective alert icon and the respective alert icon is not associated with a respective application, expanding the respective alert icon to display additional information about the alert.

12. The method of claim 1, wherein detecting the occurrence of the alert comprises detecting occurrence of a first alert; displaying in the status bar the indication of the alert includes displaying a respective alert icon indicative of the first alert; and
the method includes, concurrently displaying in the status bar, the respective alert icon indicative of the first alert and one or more additional alert icons indicative of one or more alerts different from the first alert.

13. The method of claim 12, wherein concurrently displaying in the status bar, the respective alert icon indicative of the first alert and the one or more additional alert icons indicative of one or more alerts different from the first alert includes:
displaying a second alert icon indicative of a second alert that is different from the one or more status icons and that indicates a state of a second function of the computer system; and
displaying a third alert icon indicative of a third alert that corresponds to a third status icon of the one or more status icons, including updating the third status icon to include an indication of an occurrence of the third alert.

14. The method of claim 1, wherein detecting the occurrence of the alert includes detecting that one or more battery criteria have been met, and the indication of the alert corresponds to a battery alert icon.

15. The method of claim 1, wherein detecting the occurrence of the alert includes detecting that a screen recording is initiated.

16. The method of claim 1, wherein detecting the occurrence of the alert includes detecting that the computer system has entered a restricted mode.

17. The method of claim 1, wherein detecting the occurrence of the alert includes detecting that media sharing is active.

18. The method of claim 1, including, while displaying the indication of the alert:
while the display generation component is in a first orientation, displaying the status bar, including the one or more status icons and the indication of the alert, at a first position of the display generation component in the first orientation; and
in response to detecting an event that causes the display generation component to change from the first orientation to a second orientation, displaying the status bar, including the one or more status icons and the indication of the alert, at the first position of the display generation component in the second orientation.

19. The method of claim 1, wherein displaying, outside of the status bar, the user interface of respective software executing on the computer system includes displaying a system user interface while concurrently displaying the status bar.

20. The method of claim 1, wherein displaying, outside of the status bar, the user interface of respective software executing on the computer system includes displaying an application user interface for an application of the computer system, while concurrently displaying the status bar.

21. A computer system, comprising:
a display generation component;
one or more processors; and
memory storing one or more programs, wherein the one or more programs are configured to be executed by the one or more processors, the one or more programs including instructions for:
displaying, via the display generation component, a status bar that includes one or more status icons, wherein a first status icon of the one or more status icons indicates a state of a first function of the computer system;
displaying outside of the status bar, via the display generation component, a user interface of respective software executing on the computer system;
detecting an occurrence of an alert; and
in response to detecting the occurrence of the alert, while continuing to display the user interface of the respective software outside of the status bar, displaying in the status bar an indication of the alert, including:
in accordance with a determination that the alert corresponds to the first status icon of the one or more status icons in the status bar, updating the first status icon to include an indication of an occurrence of the alert;
detecting an input directed to the status bar; and
in response to detecting the input directed to the status bar:
in accordance with a determination that the input is directed to the first status icon in the status bar, performing a first operation; and
in accordance with a determination that the input is directed to a second status icon in the status bar, wherein the second status icon is different from the first status icon, forgoing performing the first operation.

22. A computer readable storage medium storing one or more programs, the one or more programs comprising instructions that, when executed by a computer system with a display generation component, cause the computer system to:
display, via the display generation component, a status bar that includes one or more status icons, wherein a first status icon of the one or more status icons indicates a state of a first function of the computer system;
display outside of the status bar, via the display generation component, a user interface of respective software executing on the computer system;
detect an occurrence of an alert; and
in response to detecting the occurrence of the alert, while continuing to display the user interface of the respective software outside of the status bar, display in the status bar an indication of the alert, including:
in accordance with a determination that the alert corresponds to the first status icon of the one or more status icons in the status bar, update the first status icon to include an indication of an occurrence of the alert;
detect an input directed to the status bar; and
in response to detecting the input directed to the status bar:
in accordance with a determination that the input is directed to the first status icon in the status bar, perform a first operation; and
in accordance with a determination that the input is directed to a second status icon in the status bar, wherein the second status icon is different from the first status icon, forgo performing the first operation.
